(19) United States
(12) Patent Application Publication
(10) Pub. No.: US 2019/0102262 A1
(43) Pub. Date: Apr. 4, 2019

(54) AUTOMATED CONTINUOUS CHECKPOINTING

(71) Applicant: Intel Corporation, Santa Clara, CA (US)

(72) Inventors: Vadim SUKHOMLINOV, Santa Clara, CA (US); Kshitij A. DOSHI, Tempe, AZ (US); Tamir D. MUNAFO, Har-Hotzbim (IL); Sanjeev N. TRIKA, Portland, OR (US); Urvi PATEL, Folsom, CA (US); Rowel S. GARCIA, Hillsboro, OR (US)

(21) Appl. No.: 15/721,625

(22) Filed: Sep. 29, 2017

(51) Int. Cl. G06F 11/14

(52) U.S. Cl. CPC G06F 11/1469; G06F 2201/84; G06F 11/1471; G06F 11/1448

(57) ABSTRACT

A storage controller performs continuous checkpointing. With continuous checkpointing, the information necessary for system rollback is continuously recorded without the need of a specific command. With the rollback information, the system can rollback or restore to any previous state up to a number of previous writes or up to an amount of data. The number of writes or the amount of data that can be restored are configurable.

### FIELD

The descriptions are generally related to storage systems, and more particular descriptions are related to restoration of a previous state of stored data.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright © 2017, Intel Corporation, All Rights Reserved.

### BACKGROUND

Computer security is a long standing issue for users. Despite anti-malware tools and services, there continues to be an increase in malware affecting computing devices. With the introduction of ransomware, attackers can write a malicious payload that encrypts the machine and shuts the user out of the computing device. The various data loss and recovery mechanisms that exist, such as recycle bins and undelete software, rely on legacy data being stored in accessible sectors of the drive. But corruption and encryption can make the legacy data inaccessible.

Making backup copies is a common approach for recovery, but has many limitations. One limitation is the extra storage required. For network-based backups, network access is also required. Thus, backups traditionally impact cost, power, and performance of the system. Additionally, backups are scheduled on a regular basis, such as daily, hourly, or on some other schedule, where changes made between scheduled backups is lost even if recovery is made. Traditional approaches to data recovery involve the proactively copying of files for backup, or creating new versions of the existing data. Some systems attempt to reduce the copying and creating load by copying only files that have changed between backups (saving only the “delta” or difference). Mirroring systems can reduce the risk of data loss from a drive failure, but does not protect against malware, which will be copied to the mirror as well as the original.

Other traditional approaches can include shadow-versions and volume-shadow-copies, which involve the operating system (OS) keeping multiple copies of the data. Such approaches are OS-specific and require a significant amount of additional I/O (input/output) between the host and the storage device. Previous approaches to checkpointing require the host to periodically issue checkpoint commands. The issuance of checkpoint commands places additional burden on the host, and similar to other recovery approaches, changes made between checkpoint commands are lost.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, and/or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1A is a block diagram of an embodiment of a system with a solid state drive (SSD) with a controller that has write control with continuous checkpointing.

FIG. 1B is a block diagram of an embodiment of a system with a solid state drive (SSD) with a controller with programmable firmware to implement continuous checkpointing.

FIG. 1C is a block diagram of an embodiment of a system with a nonvolatile media device with programmable firmware in the host to implement continuous checkpointing.

FIG. 2 is a block diagram of an embodiment of a system with a solid state drive (SSD) with checkpointing in a translation layer.

FIG. 3A is a block diagram of an embodiment of a system that implements continuous checkpointing with a closed channel SSD.

FIG. 3B is a block diagram of an embodiment of a system that implements continuous checkpointing with an open channel SSD.

FIG. 4 is a block diagram of an embodiment of a log for continuous checkpointing.

FIG. 5 is a diagrammatic representation of an embodiment of pseudocode for maintaining global state in a checkpointing ledger.

FIG. 6 is a diagrammatic representation of an embodiment of pseudocode for writing a page in a checkpointing environment.

FIG. 7 is a diagrammatic representation of an embodiment of pseudocode for creating an erase unit in a checkpointing environment.

FIG. 8 is a diagrammatic representation of an embodiment of pseudocode for identifying write order in a checkpointing environment.

FIG. 9 is a diagrammatic representation of an embodiment of pseudocode for garbage collection in a checkpointing environment.

FIG. 10 is a diagrammatic representation of an embodiment of pseudocode for rollback based on continuous checkpointing.

FIG. 11 is a diagrammatic representation of an embodiment of pseudocode for reading old data without rollback based on continuous checkpointing.

FIG. 12 is a flow diagram of an embodiment of operations for continuous checkpointing.

FIG. 13 is a block diagram of an embodiment of a computing system in which continuous checkpointing can be implemented.

FIG. 14 is a block diagram of an embodiment of a mobile device in which continuous checkpointing can be implemented.

Descriptions of certain details and implementations follow, including a description of the figures, which may depict some or all of the embodiments described below, as well as discussing other potential embodiments or implementations of the inventive concepts presented herein.

### DETAILED DESCRIPTION

As described herein, a storage controller performs continuous checkpointing. With continuous checkpointing, the information necessary for system rollback is continuously recorded without the need of a specific command. The continuous checkpointing from the storage controller enables data recovery at any granularity, independent of the operating system. With the rollback information, the system can rollback or restore to any previous state up to a number of previous writes or up to an amount of data. The number of writes recoverable or the amount of data that can be rolled back are configurable.

In one embodiment, continuous checkpointing includes keeping a history of write transactions, and enabling rollback of a configurable number of vectors or write transactions. For example, the system can enable the rollback of anywhere from 1 to N vectors or roll back to any of the last N writes. To enable the rollback, it will be understood that the system will maintain the last N writes; thus, for example, the system will not overwrite the data blocks for the last N writes. In one embodiment, the last N writes refers to actual write transactions, and up to N transactions can be rolled back. In one embodiment, the last N writes refers to writes affecting an amount of data N, and write up to that amount of data can be rolled back.

The amount of rollback is configurable. In one embodiment, a user sets the amount of rollback recovery desired. In one embodiment, the amount of rollback is configured by an administrator. In one embodiment, the system has a default amount of rollback configured. In one embodiment, the configurability includes the ability to set an amount of data that can be recovered (e.g., the last 10 GB of writes). In one embodiment, the configurability includes the ability to set an amount of time that can be recovered (e.g., an hour, a day, a week, or some other amount of time). While the total capability can be configured, it will be understood that any write within the total capability can be recovered.

By enabling rollback as described herein, the user can recover from accidental deletion, virus or malware corruption, ransomware, or other corruption of storage state by returning to a previous state of storage. The rollback described has a minimal cost and performance impacts by enabling recovery directly out of the write operation of the computing device. It will be understood that to enable recovery, the system will maintain the data from previous states of the storage, or before the most recent writes. If the data is overwritten, it would generally not be recoverable. The recovery can be controllable depending on how much of data rollback is needed. It will be understood that the continuous checkpointing data recover can have application to general file recovery situations, forensic analysis, anti-malware, and anti-ransomware domains.

In one embodiment, a recovery system enables the rollback to an older data state of a nonvolatile drive without requiring the host (e.g., a host operating system) to issue a checkpoint command. Thus, the recovery system can enable a continuous granularity of recovery based on “commandless” versioning. In one embodiment, the system enables access or read of the older data state without recovering to the older data state. In one embodiment, the recovery system enables rollback in units of sectors written. In one embodiment, the recovery system enables rollback in units of time. In either case the maximum units of time or sectors written can be a configurable maximum. The versioning can be considered “commandless” because it happens within the storage controller or within the write algorithm, and does not require an explicit command from the host. Traditional versioning required commands from the host, which limited the ability of the system to recover. The commandless operation of versioning enables finer granularity recovery.

The recovery system includes a storage controller that writes to new locations rather than overwriting locations. Performing writes to new locations requires back space reclaim to recover the space as unused space for future write transactions. The recovery system also includes the ability to log the previous data states and new data states. In one embodiment, the recovery system includes a ledger data structure in the storage controller to track previous locations (e.g., physical addresses associated with logical addresses). In one embodiment, the ledger data structure ensures that previous locations are not erased prematurely.

It will be understood that restoration of storage state can be faster as a native operation of a storage controller versus the operation through an operating system. Additionally, traditional restoration is frequently performed based on local or network replication systems. With replication systems, the replicated system typically copies the data over a network link to make a remote duplicate of the system. The system can be restored by copying the data back. Replication systems are primarily focused on physical disasters, but can be used to recover from a cyber-attack. With the continuous checkpointing as described herein, restoration can avoid the need of resending data, seeing that the data is locally stored and can be used to make the restore easier. When performed locally, the restore is faster, reduces network bandwidth, and can improve power performance.

Reference to nonvolatile memory refers to memory or storage whose state is determinate even if power is interrupted to the memory. Nonvolatile memory is in contrast to volatile memory whose state (and therefore the data stored on it) is indeterminate if power is interrupted to it. Volatile memory is typically used as system main memory, and traditionally has less capacity than nonvolatile memory, but has much faster access times. A device with nonvolatile media, referring to the hardware resources used to store data, can be referred to as a nonvolatile memory device or storage device.

In one embodiment, the nonvolatile memory device is a block addressable memory device, such as NAND or NOR technologies, as used for flash memory. The nonvolatile medium can include flash or can include a future generation nonvolatile device, such as a three dimensional crosspoint memory device, or other byte addressable nonvolatile memory devices, or memory devices that use a chalcogenide phase change material (e.g., chalcogenide glass). In one embodiment, the memory device can be or include multi-threshold level NAND flash memory, NOR flash memory, single or multi-level Phase Change Memory (PCM), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory.

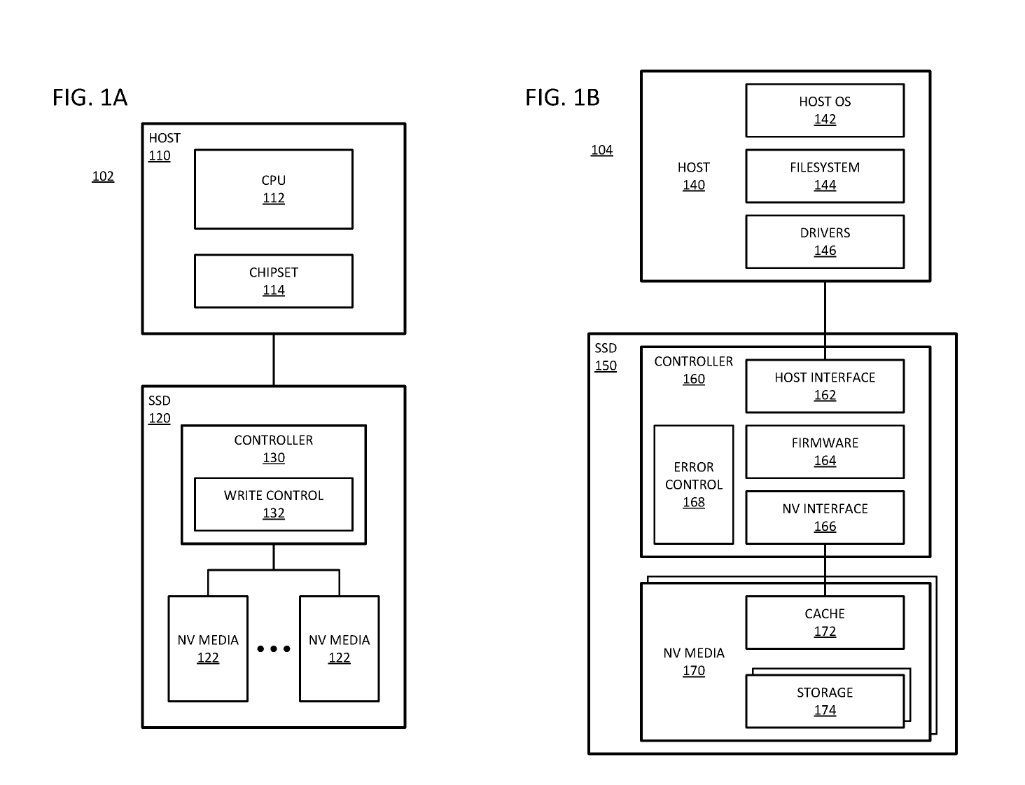

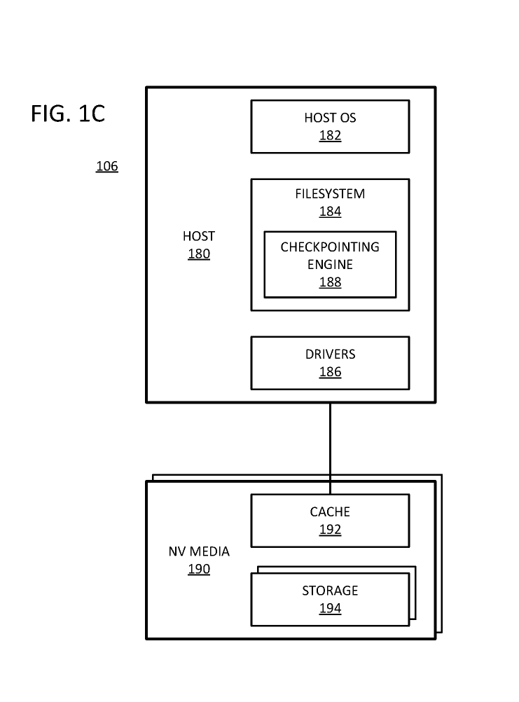

FIG. 1A is a block diagram of an embodiment of a system with a solid state drive (SSD) with a controller that has write control with continuous checkpointing. System 102 includes SSD (solid state drive) 120 coupled with host 110. Host 110 represents a host hardware platform that connects to SSD 120. Host 110 includes CPU (central processing unit) 112 or other processor as a host processor. CPU 112 represents any host processor that generates requests to access data stored on 120, either to read the data or to write data to the storage. Such a processor can include a single or multicore processor, a primary processor for a computing device, a graphics processor, a peripheral processor, or a supplemental or auxiliary processor, or a combination. CPU 112 can execute a host operating system (OS) and other applications to cause the operation of system 102. Host 110 includes chipset 114, which represents hardware components that can be included in connecting between CPU 112 and SSD 120. For example, chipset 114 can include interconnect circuits and logic to enable access to SSD 120. In one embodiment, chipset 114 includes a storage controller, which is a host-side controller that is separate from controller 130 within SSD 120.

SSD 120 represents a solid state drive that includes NV (nonvolatile) media 122 to store data. SSD 120 includes controller 130 to control access to NV media 122. In one embodiment, controller 130 includes an interface to NV media 122, and includes an interface to host 110. Controller 130 is specifically illustrated to include write control 132, which represents hardware and control logic to control the writing to NV media 122. Controller 130 has command sequences for reading and writing to the memory cells of NV media 122, and write control 132 can represent the write sequence in accordance with what is described herein. Write control 132 can implement writes to NV media 122 in accordance with what is described herein, where writes are written to unused address space or blocks. The previously data is not immediately overwritten, but can be recovered by a rollback operation.

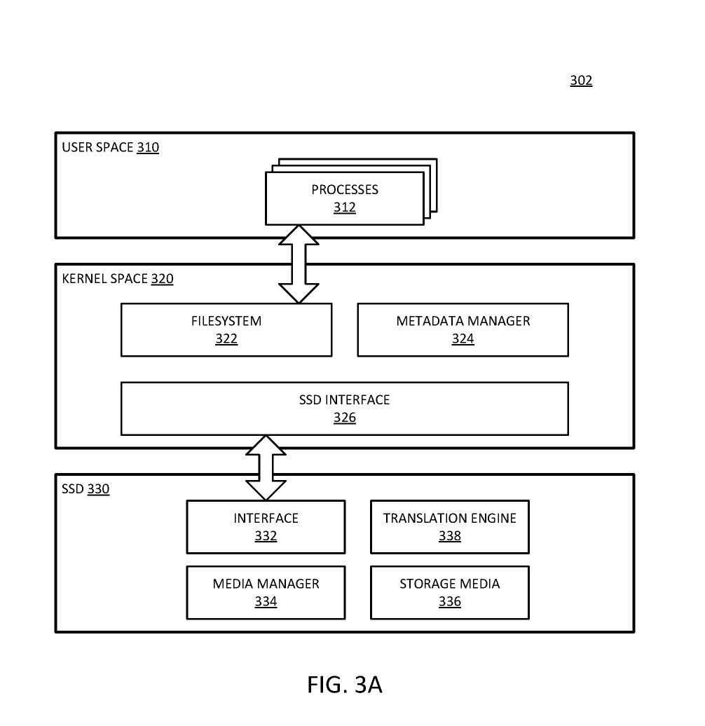

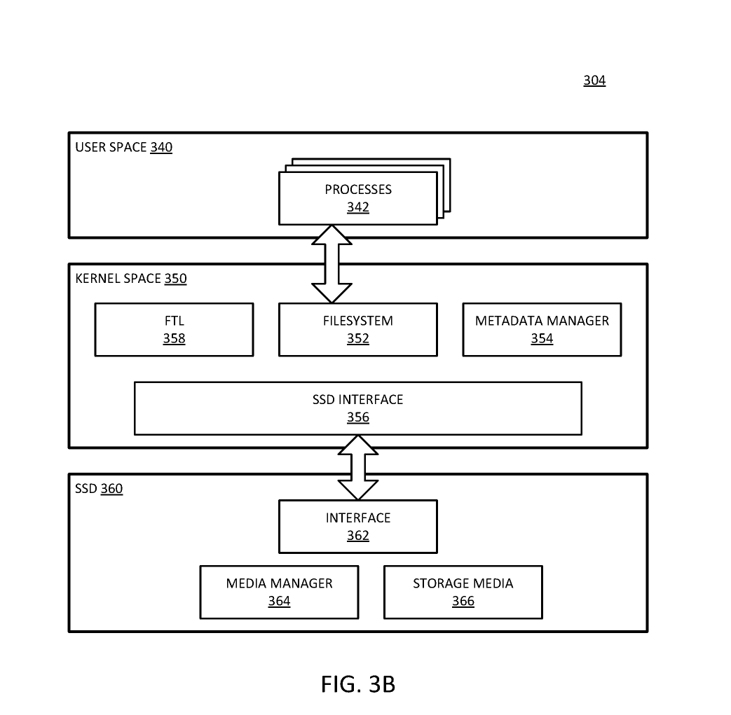

System 102 includes a storage controller to implement continuous checkpointing. In one embodiment, the storage controller is part of controller 130, for a closed channel SSD 120 (such as in FIG. 3A). In one embodiment, the storage controller is part of chipset 114, for an open channel SSD 120 (such as in FIG. 3B). In one embodiment, the storage controller keeps track of the last X data vectors or the association of a logical address with previous physical addresses. The associations with previous physical addresses refers to physical addresses previously associated with the logical address. The previous physical addresses store the stale data until they are rewritten or erased. In one embodiment, all writes are considered modifications to data, seeing that they modify the state of data in SSD 120.

With the storage controller tracking data modification, system 102 can provide automatic and continuous checkpointing, without imposing significant additional computations or I/O on host 110. In one embodiment, write control 132 performs low level media management operations that keep previous copies of data available in SSD 120. In one embodiment, the storage controller leverages such previous copies by preventing their reclamation to allow for rollback operations. In one embodiment, the storage controller generates and manages log information, which can provide an I/O history that can be used to easily identify specific flows. In one embodiment, the I/O history can identify flows of writes an OS level. In one embodiment, the I/O history can identify flows on process, thread, or component level, or a combination. For example, either the operating system or a security agent (e.g., security software executing under the OS) can determine the latest LBA (logic block address) written before corruption was observed. Being able to identify a specific LBA prior to corruption can trace the write back to malware that may be otherwise hidden on a machine.

It will be understood that while system 102 is illustrated with SSD 120, other nonvolatile media can be used. In general, the continuous checkpointing can be implemented in any storage system that includes indirection, has background address space reclaiming, and implements a log of the writes. In one embodiment, the log is a structured log of write data to identify previous logical-physical address associations. Thus, while system 102 can represent a computer system with a host operating system and a NAND SSD to store data, system 102 can alternatively include software systems, SPI (serial peripheral interface) storage or storage connected to a SPI bus, LSM-based (log-structured-merge-based) key-value solutions, three-dimensional crosspoint (3DXP) memory based solutions, or other storage systems. In one embodiment, the storage controller utilizes volatile memory (e.g., a dynamic random access memory (DRAM) device, a synchronous random access memory (SRAM) device, or other) to store the log information. The log information can alternatively be referred to as SSD state information or a ledger. For a storage controller at host 110, the host can include the memory for the ledger. For a storage controller at SSD 120, the SSD can include the memory for the ledger.

FIG. 113 is a block diagram of an embodiment of a system with a solid state drive (SSD) with a controller with programmable firmware to implement continuous checkpointing. System 104 provides one example of a system in accordance with system 102 of FIG. 1A. System 104 illustrates the logical layers of the host and SSD of a hardware platform in accordance with system 102. In one embodiment, host 140 provides one example of host 110. In one embodiment, SSD 150 provides one example of SSD 120.

In one embodiment, host 140 includes host OS 142, which represents a host operating system or software platform for the host. Host OS 142 can include a platform on which applications, services, agents, and/or other software executes, and is executed by a processor. Filesystem 144 represents control logic for controlling access to the NV media. Filesystem 144 can manage what addresses or memory locations are used to store what data. There are numerous filesystems known, and filesystem 144 can implement known filesystems or other proprietary systems. In one embodiment, filesystem 144 is part of host OS 142. Drivers 146 represent system-level modules that control hardware. In one embodiment, drivers 146 include a software application to control the hardware of SSD 150.

Controller 160 of SSD 150 includes firmware 164, which represents control software/firmware for the controller. In one embodiment, controller 160 includes host interface 162, which represents an interface to host 150. In one embodiment, controller 160 includes NV interface 166, which represents an interface to NV media device(s) 170. It will be understood that controller 160 includes hardware to interface with host 140, which can be considered to be controlled by host interface software/firmware 162. Likewise, it will be understood that controller 160 includes hardware to interface with NV media 170. In one embodiment, code for host interface 162 can be part of firmware 164. In one embodiment, code for NV interface 166 can be part of firmware 164.

Firmware 164 controls the hardware interfaces to enable communication. In one embodiment, firmware 164 includes a storage controller that performs continuous checkpointing in accordance with what is described above. It will be understood that more hardware implementation within controller 160 will increase the speed of operation of the SSD. Thus, command sequences can be implemented in firmware (e.g., firmware 164 or NV interface 166), but firmware is generally slower than hardware. Firmware is more flexible because it can perform more operations and be modified, but hardware is generally much faster than firmware implementations. It will be understood that there are aspects of interaction that are handled in firmware in all cases, seeing that the firmware controls the hardware. However, firmware implementation refers to an implementation in which all sequencing and all processing of signals is performed in firmware controlled logic. A hardware implementation includes hardware processing of at least some of the signal exchanges. Firmware control over the hardware needs to be compatible with both the hardware interface of controller 160, as well as the hardware and firmware of NV device 170.

An example of hardware versus firmware can be represented by error control 168. Error control 168 handles data errors in accessed data, and corner cases in terms of compliance with signaling and communication interfacing. It is possible to implement at least some of error control in hardware. However, most error control is implemented in firmware for the flexibility, even if it is slower than a hardware implementation. A hardware implementation may require an impractical amount of hardware logic to implement. Similarly, in one embodiment, firmware 164 handles erase operations and drive cleanup procedures.

NV media 170 represents a nonvolatile device in accordance with any embodiment described herein. In one embodiment, NV media 170 includes cache 172, which represents an input or output buffer or cache to store temporary data for exchange with controller 160. The use of cache 172 can enable NV device 170 to receive commands asynchronously, and still operate on and respond to the command synchronously. The timing can be made synchronous by buffering the data in cache 172. Storage 174 represents the storage locations of NV media 170.

In one embodiment, firmware 164 implements logic for a storage controller that performs checkpointing operations. Firmware 164 can include the logic to implement log or ledger management. In one embodiment, filesystem 144 can implement logic for a storage controller that performs checkpointing operations. Filesystem 144 can include the logic to implement log or ledger management. Wherever the storage controller is implemented, the storage controller can track write vectors to enable rolling back a state of the storage. In one embodiment, firmware 164 or filesystem 144 or a combination can expose APIs (application programming interfaces) to enable checkpointing operations. In one embodiment, a user requests a data state rollback via an application that utilizes an API to access the rollback functionality.

In one embodiment, system 104 can provide rollback capability for SSD 150 in units of amount of data written, or in units of time, or a combination. For example, host 140 can request rollback to revert SSD 150 to a state it had X sectors of writes earlier. As another example, host 140 can request rollback to revert SSD 150 to the state it had Y minutes ago. X and Y could be small or large numbers, and Y can be fractional, with configurable maximum values. It will be understood that a higher maximum has a tradeoff of higher cost to implement. In one embodiment, through the storage controller, host 140 can query SSD 150 to query the drive-state at a previous time, without performing a rollback. Thus, for example, host 140 can read a previous state without reverting SSD 150 to the previous state.

FIG. 1C is a block diagram of an embodiment of a system with a nonvolatile media device with programmable firmware in the host to implement continuous checkpointing. System 106 provides one example of logical layers of a host and a nonvolatile media device that does not include a controller. Whereas the SSD provides one example of a nonvolatile storage device, it will be understood that an SSD or a nonvolatile storage device without a controller can be used in place of SSD 120 of system 102. In one embodiment, the nonvolatile storage device can be or include an embedded storage device, such as flash storage embedded on the hardware platform or motherboard of a computing device with a host processor.

In one embodiment, host 180 includes host OS 182, which represents a host operating system or software platform for the host that executes on a processor or CPU. Host OS 182 can include a platform on which applications, services, agents, and/or other software executes, and is executed by a processor. Filesystem 184 represents control logic for controlling access to the NV media. Filesystem 184 can manage what addresses or memory locations are used to store what data. There are numerous filesystems known, and filesystem 184 can implement known filesystems or other proprietary systems. In one embodiment, filesystem 184 is part of host OS 182. Drivers 186 represent system-level modules that control hardware. In one embodiment, drivers 186 include a software application to control a hardware interface to NV media 190.

NV media 190 represents a nonvolatile device in accordance with any embodiment described herein. In one embodiment, NV media 190 represents an embedded storage device. In one embodiment, NV media 190 includes cache 192, which represents an input or output buffer or cache to store temporary data for exchange with host 180. The use of cache 192 can enable NV device 190 to receive commands asynchronously, and still operate on and respond to the command synchronously. The timing can be made synchronous by buffering the data in cache 192. Storage 194 represents the storage locations of NV media 190.

Filesystem 184 controls the hardware interfaces to enable communication between host 180 and NV media 190. In one embodiment, filesystem 184 includes a storage controller that performs continuous checkpointing in accordance with what is described above. In one embodiment, filesystem 184 includes checkpointing engine 188 to perform the continuous checkpointing. Checkpointing engine 188 represents logic within filesystem 184 to implement log or ledger management. In one embodiment, checkpointing engine can track write vectors to enable rolling back a state of storage 194. In one embodiment, filesystem 184 can expose APIs to enable access to checkpointing engine 188 for checkpointing operations. In one embodiment, a user requests a data state rollback via an application that utilizes an API to access the rollback functionality.

In one embodiment, system 104 can provide rollback capability for NV media 190 in units of amount of data written, or in units of time, or a combination. For example, host 180 can request rollback to revert NV media 190 to a state it had X sectors of writes earlier. As another example, host 180 can request rollback to revert NV media 190 to the state it had Y minutes ago. X and Y could be small or large numbers, and Y can be fractional, with configurable maximum values. It will be understood that a higher maximum has a tradeoff of higher cost to implement. In one embodiment, through the storage controller, host 180 can query NV media 190 to query the drive-state at a previous time, without performing a rollback. Thus, for example, host 180 can read a previous state without reverting NV media 190 to the previous state.

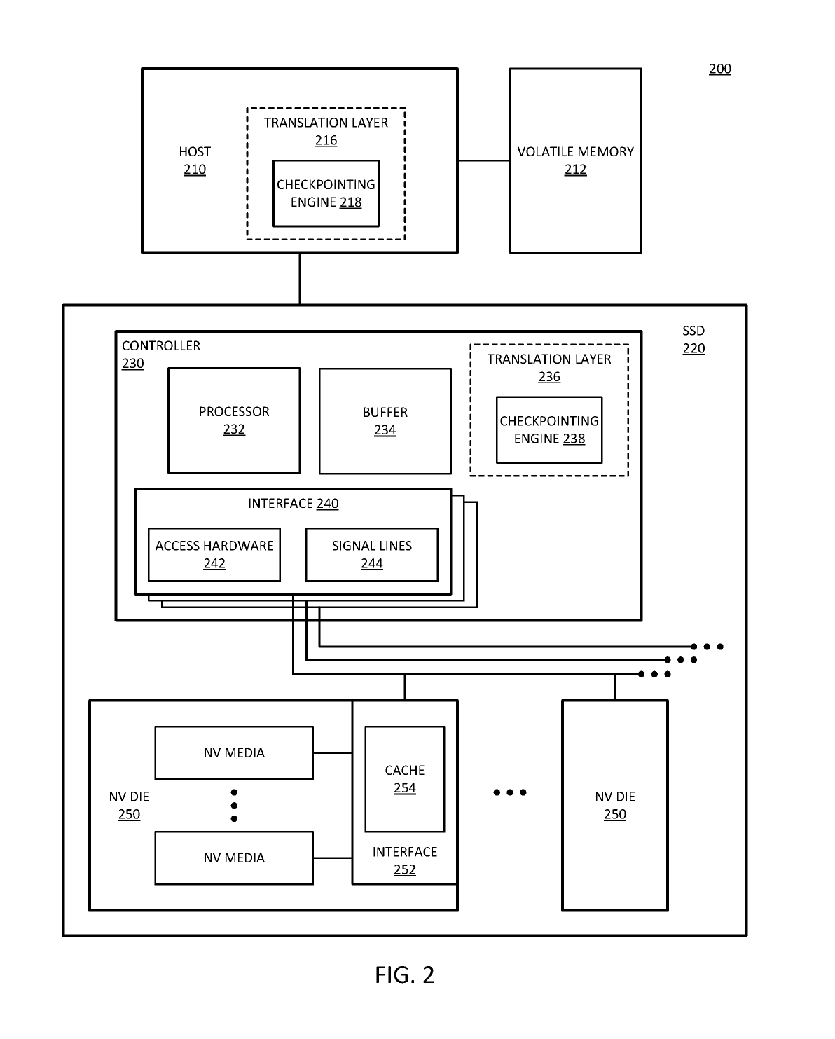

FIG. 2 is a block diagram of an embodiment of a system with a solid state drive (SSD) with checkpointing in a translation layer. System 200 provides one example of an embodiment of a computing system in accordance with system 102 of FIG. 1A or system 104 of FIG. 1B. Host 210 represents a host hardware and software platform. Host 210 generates requests for data, which requests result in data access operations to SSD 220. Host 210 can include a storage controller that controls access from host 210 to SSD 220. Such a storage controller can be distinguished from controller 230 of SSD 220. Controller 230 represents a controller on SSD 220 to manage incoming requests for data access from host 210.

In one embodiment, system 200 includes volatile memory 212, which represents volatile memory that host 210 can access for temporary storage of data. For example, memory 212 can be considered an operating memory of system 200, while SSD 220 can include storage that is not directly executed by host 210. In one embodiment, all data and code for execution by host is first loaded from SSD 220 to memory 212. In one embodiment, host 210 directly executes code or data from SSD 220, for example, by loading data into a cache (not explicitly shown). While not specifically shown, in one embodiment, SSD 220 is coupled to memory 212, and can transfer data to or from memory 212, such as loading a program for execution by a host processor, writing data generated by a host application, or other action.

In one embodiment, controller 230 is a custom device (e.g., an ASIC), which includes processor 232, buffer 234, and one or more NV storage interfaces 240. Processor 232 represents a microprocessor or microcontroller or other processing logic on controller 230 that enables controller 230 to execute operations related to processing incoming requests and access the nonvolatile media in response to the requests. It will be understood that processor 232 is separate from a processor included in host 210 as part of the host hardware platform. Buffer 234 represents a buffer or cache within controller 230 that enables SSD 220 to receive and buffer multiple requests or instructions and/or write data from host 210. Buffer 234 can also represent a buffer or cache to buffer data to be output to host 210 (e.g., read data). In one embodiment, controller 230 includes separate ingress and egress buffers 234.

Interface 240 represents hardware and software/firmware within controller 230 to enable access to NV die 250. In one embodiment, controller 230 includes multiple interfaces 240, each of which can connect to multiple NV die 250. Each NV die 250 includes 2N planes, and includes interface 252 to couple to a corresponding interface 240 of controller 230. In one embodiment, interface 254 includes cache 254 to store received requests and write data, or to store read data.

Interfaces 240 include access hardware 242, which represents hardware drivers and interface circuits to generate and receive signals with NV die 250. Access hardware 242 can include processing hardware to support the processing of data exchanges between controller 230 and the NV media. Signal lines 244 can in one embodiment be considered access hardware 242. Signal lines 244 are illustrated to represent that SSD 220 includes one or more physical buses from interface 240 to NV die 250.

In one embodiment, system 200 includes a translation layer to include or work in conjunction with a storage controller that provides continuous checkpointing capabilities. In one embodiment, system 200 includes translation layer 216 in host 210. In one embodiment, system 200 includes translation layer 236 in controller 230 of SSD 220. Translation layer 216 is illustrated including checkpointing engine 218, which represents logic to maintain log information and ensure the accessibility of prior data. The accessibility and the log information can be in accordance with a configured parameter in host 210, where the parameter identifies a rollback capability for the state of SSD 220. Translation engine 236 can include checkpointing engine 238 as comparable logic to what is described for checkpointing engine 218.

In one embodiment, checkpointing engine 218 or 238 can detect and prevent attacks that would compromise the ability to perform rollback. For example, for rollback capability based on a number of writes, the checkpointing engine can detect continuous writing by an agent to prevent an attack from continuously writing to remove the rollback capability. In one embodiment, the checkpointing engine can require explicit authorization from the user to perform extensive writes, for example, by momentarily halting writes beyond a threshold (e.g., a percentage of the maximum rollback threshold) and request confirmation from the user before allowing the agent to continue writing.

The checkpointing engine (either 218 or 238), can maintain a log of a most recent N writes, with N representing a configurable amount of data for rollback. The checkpointing engine can maintain the stale data for the most recent N writes. In one embodiment, the N writes indicates a number of writes that occur within a time period. In one embodiment, the N writes indicates an amount of storage capacity or a volume of write data. In one embodiment, by keeping log data, system 200 can enable a user to roll back the state of SSD 220 to any granularity from 1 unit previous to N units previous. In one embodiment, the checkpointing engine enables reading any state within the N units of write, but not rolling the state back. Rollback of the state includes associating a logical address with a previous physical address where stale data is stored. Reading without rollback includes reading the data of the previous physical address without changing the logic address association. Rollback includes changing what data is considered active. Reading without rollback does not change the active data.

In one embodiment, the checkpointing engine maintains the stale data by preventing garbage collection of the data. For example, a garbage collector process can be provide with modified operation to prevent reclaiming a physical address space when it contains data that is within the rollback capability of the system. In one embodiment, the checkpointing engine maintains the stale data by preventing defragmentation of the data, where valid portions of data blocks are combined to fill a data block from multiple blocks that have dirty or stale portions. In one embodiment, defragmentation can be considered a special case of garbage collection. In one embodiment, defragmentation can be considered the same operation as garbage collection.

FIG. 3A is a block diagram of an embodiment of a system that implements continuous checkpointing with a closed channel SSD. System 302 represents a closed channel SSD. System 302 illustrates user space 310 and kernel space 320, which represent environments executed by a host processor. The host processor provides control of a system in which SSD 330 is incorporated. Kernel space 320 represents an environment provided by a host operating system (OS) executing on the host processor. User space 310 represents an environment of user-level components or user-facing agents executed by the host processor. The components within user space 310 rely on control logic of kernel space 320 for access to SSD 330. Kernel space 320 can include drivers that control and interface directly with hardware interface components that interconnect with SSD 330.

User space 310 includes processes 312, which represent applications, programs, or agents in the host system. Processes 312 can represent individual programs, processes, threads, or a combination. Kernel space 320 includes filesystem 322, which represents logic to control the storage of processes 312 in SSD 330, or the data utilized by the processes, or a combination. Many filesystems are known, and can be utilized in system 302. Kernel space 320 include metadata manager 324, which represents logic to manage the metadata associated with data stored in SSD 330. The metadata can include information about the data stored in SSD 330, such as read and write logs, dirty data logs, address information, or other information.

SSD interface 326 represents logic to access the SSD. SSD interface 326 enables kernel space 320 to send read requests and write data to SSD 330. SSD interface 326 ca include a buffer and drivers to communication with SSD interface 332 of SSD 330. SSD interface 332 represents logic to enable access to the SSD by kernel space 320, and can be the same or similar to SSD interface 326 from the SSD side. Media manager 334 represents logic at SSD 330 to control access to storage media 336. Storage media 336 represents the storage locations where data is stored within SSD 330. Storage media 336 includes addressable memory locations, which can be memory blocks.

In one embodiment, SSD 330 includes translation engine 338, such as a flash translation layer (FTL). Translation engine 338 provides indirection to identify the physical addresses space for logical addresses such as logical block addresses (LBAs) of requests received from filesystem 322. In one embodiment, translation engine 338 is part of media manager 334. In one embodiment, translation engine 338 provides continuous checkpointing in accordance with an embodiment of checkpointing as described herein.

FIG. 3B is a block diagram of an embodiment of a system that implements continuous checkpointing with an open channel SSD. System 304 represents an open channel SSD. In one embodiment, many or most of the components of system 304 can be the same as system 302. In system 304 the indirection layer is included in the host side instead of the SSD side. System 304 illustrates user space 340 and kernel space 350, which represent environments executed by a host processor. The host processor provides control of a system in which SSD 360 is incorporated. Kernel space 350 represents an environment provided by the host OS executing on the host processor. User space 340 represents an environment of user-level components or user-facing agents executed by the host processor. The components within user space 340 rely on control logic of kernel space 350 for access to SSD 360. Kernel space 350 can include drivers that control and interface directly with hardware interface components that interconnect with SSD 360.

User space 340 includes processes 342, which represent applications, programs, or agents in the host system. Processes 342 can represent individual programs, processes, threads, or a combination. Kernel space 350 includes filesystem 352, which represents logic to control the storage of processes 342 in SSD 360, or the data utilized by the processes, or a combination. Many filesystems are known, and can be utilized in system 302. Kernel space 350 include metadata manager 354, which represents logic to manage the metadata associated with data stored in SSD 360. The metadata can include information about the data stored in SSD 360, such as read and write logs, dirty data logs, address information, or other information.

SSD interface 356 represents logic to access the SSD. SSD interface 356 enables kernel space 350 to send read requests and write data to SSD 360. SSD interface 356 ca include a buffer and drivers to communication with SSD interface 362 of SSD 360. SSD interface 362 represents logic to enable access to the SSD by kernel space 350, and can be the same or similar to SSD interface 356 from the SSD side. Media manager 364 represents logic at SSD 360 to control access to storage media 366. Storage media 366 represents the storage locations where data is stored within SSD 360. Storage media 366 includes addressable memory locations, which can be memory blocks.

In one embodiment, kernel space 350 includes FTL (flash translation layer) 358, which provides one example of a translation layer. FTL 358 provides indirection to identify the physical addresses space for logical addresses such as logical block addresses (LBAs) of requests to send to SSD 360. In one embodiment, FTL 358 provides continuous checkpointing in accordance with an embodiment of checkpointing as described herein.

Whether referring to translation layer 338 of system 302 or FTL 358 of system 304, the SSD system includes an indirection element. In one embodiment, the indirection is provided with a logical to physical (L2P) table that maps logical to physical addresses. In one embodiment, the indirection includes background garbage collection (GC) or defragmentation (defrag). In one embodiment, the indirection includes bandjournaling capability. In one embodiment, the indirection includes one or more power-loss recovery algorithms. The indirection mechanisms have a sector size for managing the data. In one embodiment, the sector size is equal to the granularity of the indirection unit (IU) of the SSD (e.g., 4KB). In one embodiment, each write generated by the kernel space to the SSD (e.g., a host-write) is of a single sector.

For simplicity in description, the following terminology can be used. It will be understood that other notation or terminology can be used to describe similar concepts. Thus, the language used is only for purposes of description, and is not limiting. A page refers to a physical nonvolatile location pointed to by an IU. In one embodiment, data is written and read in units of pages. An erase unit (EU) represents a collection of pages that are erased together. For example, an EU can be a NAND erase-block (EB) or a band consisting of multiple EBs. In one embodiment, during host-writes, pages of a current EU are written in order until the EU is full, and then a blank current EU is picked for subsequent host writes. The variable S can refer to the maximum number of sector-writes that can be rolled back. In one embodiment, S can refer to a maximum amount of time a write can be rolled back. In one embodiment, S is user configurable. In one embodiment, S is manufacturer configurable. Recent Writes refer to the last S host-writes. Thus, for example, if up to 4 GB of rollback is desired, S can be set to 1 million (1×10̂6*4 KB=4 GB). Recent EUs refer to the EUs that contain the recent writes.

In one embodiment, to perform the checkpointing, the indirection element (e.g., translation layer 338, FTL 358) includes a ledger or log to keep track of sectors touched “recently”. As mentioned above, whether a sector is accessed recently can be dependent on configuration, where recent refers to the rollback capability by setting. In one embodiment, the ledger can track the latest EU written to ensure recent EUs are not erased. In one embodiment, the write algorithm of the storage media manager can be implemented as a sort of LRU (least recently used) algorithm, where more recently used EUs kick out the least recent EUs. Thus, for example, if the rollback configuration is for 4 GB, and there is 1MB of new write activity, there can be a corresponding 1MB of new EUs created by the write activity. The ledger can track the 1 MB of “most recent” EUs, and allow the “least recent” EUs to be reclaimed by garbage collection or defrag.

Traditional indirection includes a garbage collection or defrag capability (referred to simply as garbage collection for purposes of discussion below). The garbage collection enables the system to reclaim EUs. Traditionally, once an EU became available, the garbage collection would work as a background task and reclaim the space to prepare it for future writes. In one embodiment, the indirection element includes garbage collection that works as a background task, but does not reclaim the EU space until the EU is outside the “recent” window. Thus, for example, the garbage collection is prevented from overwriting an EU until the EU is no longer part of the range of EUs available for rollback. If rollback applies to S as either a number of sector writes or as an amount of time, an EU that is within S will not be defragged, and the garbage collection will reclaim the storage space only after the EU is outside of S.

In one embodiment, the indirection element includes an API or other interface to enable a user to execute a rollback. It will be understood that while the checkpointing is “commandless” and does not require interaction with a user or command from a host to maintain the data to roll back or the information needed to execute a rollback, the system will typically execute a rollback in response to a user request. For example, a user can request a rollback for a certain amount of time or an amount of storage space or write operations, and in response to the request by the user, the host or OS can generate a rollback command to trigger a rollback operation by the checkpointing engine. In one embodiment, a rollback operation undoes as many write transactions or as much write activity as the user wants to undo. In one embodiment, the rollback operation operates through BIOS (basic input/output system). In one embodiment, the rollback operation operates through the OS. The checkpointing engine can expose an API to either the BIOS or the OS, or to both the BIOS and the OS.

While description as made with reference to the storage of a solid state drive, it will be understood that the checkpointing described can apply to other nonvolatile storage following similar parameters as set out above. In one embodiment, a computer system includes a checkpointing engine to manage storage of a serial peripheral interface (SPI) flash device or other nonvolatile storage device embedded in a computer system. The SPI flash can represent any embedded storage device that stores a BIOS or a management mode engine or protected agent or other operating environment that is outside the view or management of a host OS. In one embodiment, the checkpointing can protect BIOS code or UEFI (unified extensible firmware interface) code or both.

In one embodiment, the checkpointing engine only performs rollback in response to a protected or verified command. A protected command can refer to a command that is signed by a trusted entity or the requesting entity or both. The protected command can provide assurance that the requesting entity is authorized to request the operation. Thus, the checkpointing engine can include a security module to verify the security of a rollback command prior to executing the rollback. Thus, a checkpointing engine may execute a rollback command only after verification of the security of the command. In this regard, a rollback command can refer to either changing the current state of storage to a prior state, or to reading a prior state of storage without changing the current state.

In one embodiment, the ledger of the checkpointing engine can identify specific sectors that have been recently written. In one embodiment, an API can expose the recent writes not only as an amount of writes or as a time period, but can identify the specific sectors that were written. In one embodiment, the API allows a user to select specific sectors to be rolled back, and other sectors to not be rolled back. Thus, the checkpointing as described herein can include fine granularity rollback as well as checkpointing. For example, a user can select to roll back selected sectors and leave other sectors unchanged. The rolled back sectors can be restored to a previous state of the storage, while other sectors are not rolled back to a previous state. The selective rolling back can include selecting among sectors interleaved in time. For example, if an order of write of 5 sectors was: A, B, C, D, E, in accordance with selective rollback, in one embodiment the system can roll back sectors B and E, while leaving sectors A, C, and D at their current state.

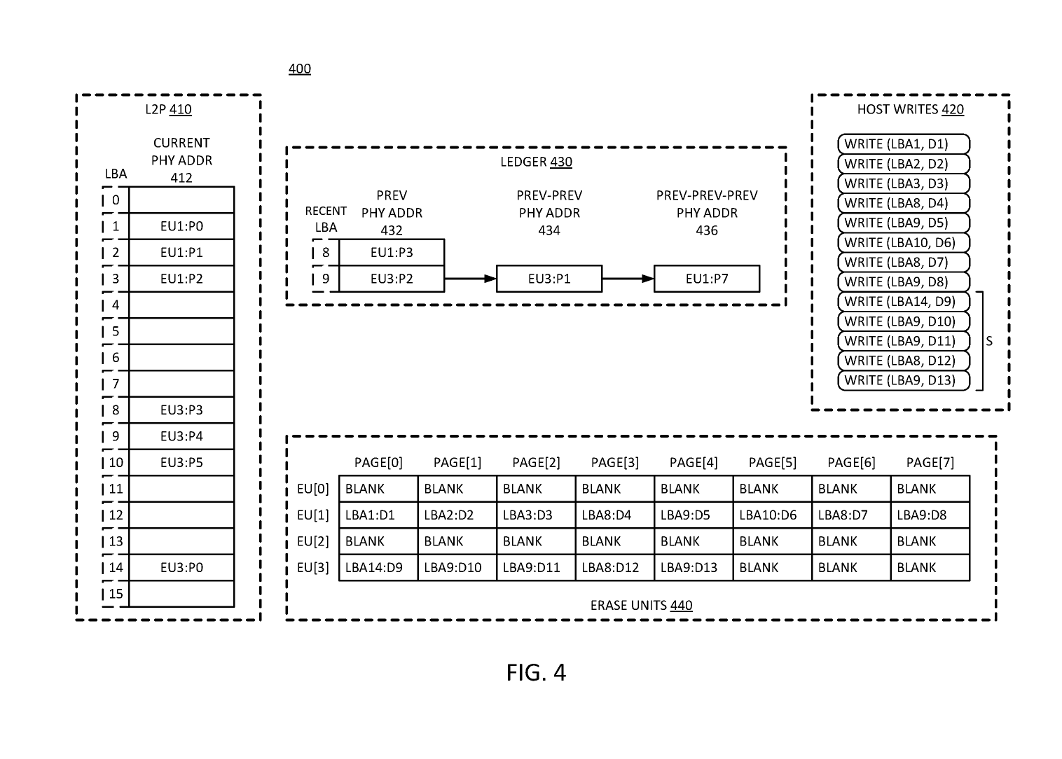

FIG. 4 is a block diagram of an embodiment of a log for continuous checkpointing. System 400 represents an example of ledger or log information maintained by a checkpointing engine in accordance with any embodiment described herein. In one embodiment, a checkpointing engine includes an indirection engine that translates logical to physical address space, and keeps additional monitoring and tracking information. The indirection engine can generate and manage the information through the execution of one or more processes or algorithms. In one embodiment, the indirection engine stores and accesses the information illustrated in system 400 in volatile memory on a hardware platform that executes the checkpointing operations.

In one embodiment, the checkpointing engine maintains a L2P (logical to physical) log 410. As illustrated, L2P 410 includes a mapping of LBA to current physical address (phy addr) 412. Where current physical address 412 does not have an entry, the LBA is not currently mapped to a physical address space.

In one embodiment, system 400 includes host writes 420, which represent a log or list of recent write activity. In one embodiment, the list is in order of write. If the list is bounded, for example by have a maximum number of entries, in one embodiment as new entries are added to host writes 420, other entries are replaced by the new entries. It will be understood that host writes 420 can be a top-down list from newest to oldest, or a bottom-up list from newest to oldest. Other configurations are also possible with metadata to track the write order.

Ledger 430 represents a mapping of previous write information. As illustrated, ledger 430 operates based on a logical block address (LBA), but could alternatively be maintained based on physical address. In one embodiment, ledger 430 represents a dictionary that maps logical addresses to a list or string of physical addresses. In one embodiment, each list is in write-order, with most recent physical address corresponding to the logical address being first or at the head. For example, consider LBA8, which is identified in L2P 410 as being associated with current physical address “EU3:P3”. Ledger 430 identifies a previous physical address (prey phy addr) 432 as “EU1:P3”. For LBA9, L2P 410 includes current physical address 412, and ledger 430 includes previous physical address 432, previous-previous physical address (prey-prey phy addr) 434, and previous-previous-previous physical address (prey-prey-prey phy addr) 436. Thus, LBA8 can be understood to have one former state available for rollback, and LBA9 has three former states available for rollback.

In one embodiment, ledger 430 only maintains entries for those recent writes that are not in L2P 410. For example, ledger 430 may have a logical address LBA in the ledger only if there are recent writes to the LBA. Thus, the only write to the LBA may be one identified in L2P 410. Thus, it will be understood that the data for the most recent write to the LBA is at the physical address identified in L2P 410. If there are more writes within the rollback parameters, ledger 430 can include longer strings than what is illustrated.

In one embodiment, system 400 references the address locations as follows. The data for the most recent write to the LBA is at the physical address at L2P[L]. The data for the second most recent write to the LBA, if it is a recent write, is at the physical address Ledger[L].Head.P. The data for the third-most recent write to the LBA, if it is a recent write, is at the physical address Ledger[L].Head.Next.P. The data for the fourth most recent write to the LBA, if it is a recent write, is at the physical address Ledger[L].Head.Next.Next.P. Next most recent writes beyond the fourth most recent write could follow a similar pattern.

In one embodiment, ledger 430 is implemented as a hash-table, with a hash-function and collision handling scheme as may be understood in the art. In one embodiment, ledger 430 has a maximum of S list nodes. In one embodiment, ledger 430 is maintained in SSD DRAM. In one embodiment, ledger 430 is stored as SPI flash filesystem metadata. In one embodiment, ledger 430 is stored as filesystem metadata on the host. In one embodiment, the information of system 400 is kept non-volatilely across power-events, either by storing it in nonvolatile memory, or by using volatile memory storing techniques, such as save on shutdown, checkpointing and rebuilds, PLI-saves, or some other technique.

Ledger 430 is illustrated as being keyed by the LBA or logical address. In one embodiment, ledger 430 is keyed by physical address, rather than logical address. In one embodiment, keying ledger 430 with logical address requires the tracking of a P2L (physical to logical) table for the multiple current EUs. When keying with the physical address instead of logical address, tracking the P2L table may not be necessary, since physical addresses can be directly used to key into the ledger, without requiring the corresponding logical address. In one embodiment, entries in ledger 430 include next/previous entries, in time-order, across LBAs. Thus, the ledger can be implemented as a doubly-linked list. A doubly-linked list can be used to reduce computation required for rollbacks.

In one embodiment, system 400 includes erase units (EUs) 440. EUs 440 provides a mapping of erase units to logical and physical address information. It will be understood that an erase unit refers to data that is no longer the current or active data, and can traditionally therefore be erased. EU data can be referred to as stale data, meaning data that is no longer the current data due to a change or a write of the data.

In one embodiment, system 400 provides tracking of recently written EUs, the oldest recent write, and P2L table (physical to logical, which can also be referred to as a band-journal) for the recent EUs. In one embodiment, system 400 maintains a list of recent EUs, in sequence order. In the oldest recent EU, in one embodiment, system 400 tracks the offset of the oldest recent write. In one embodiment, system 400 extends EU journaling (e.g., band-journaling) to maintain the P2L information for all recent EUs, and not just for the current/last EU. Such state variables enable system 400 to quickly roll back to a previous state of the nonvolatile storage represented by the physical address information, or to query an older state.

The information of system 400 can enable a checkpointing engine to provide high granularity rollback of state. For example, with ledger 430 system 400 can read a previous state of the storage by accessing the data at a previous physical address, or previous-previous physical address, or so forth. In one embodiment, system 400 can perform rollback by a number of writes, such as by monitoring host writes 420. In one embodiment, system 400 can perform rollback by time instead of by number of writes. In one embodiment, system 400 can perform rollback by time in addition to rollback by number of writes.

Rollback by time can be implemented as follows. In one embodiment, the host includes an extension to an initialization or power-up event or both, which can be considered part of system 400. In one embodiment, the host generates a timestamp to the SSD or nonvolatile storage via a new command, and the SSD tracks time internally. With such a capability, system 400 can determine the timestamp of every incoming or completing write operation.

In one embodiment, system 400 saves write timestamps in ledger 430, or in L2P 410, or in both ledger 430 and L2P 410. In one embodiment, system 400 stores timestamp information in page metadata. The timestamp information enables the SSD to track the time information of previous writes, when needed. In one embodiment, once a write is no longer a recent write, the timestamp information can be eliminated. With timestamp information, rollback can be based on reading recent write information, but system 400 can compare timestamps of entries to base rollback on time, whereas rollback based on the number of writes can involve a comparison of sequence numbers.

In one embodiment, system 400 can perform read without rollback based on tracking start timestamps for each EU. For example, system 400 can first select an EU corresponding to a duration for read-old. System 400 can then calculate page offset within the EU using timestamps per L2P and ledger entries. After such a calculation, the logic of system 400 can determine versions of an LBA as described above. In one embodiment, the host and SSD exchange timestamp information or duration information or both, and such exchanges can be in implementation specific units, granularity, and start-time. For example, the system can indicate a number of seconds since Jan. 1 2000.

In one embodiment, system 400 can provide a file-level granular rollback or version query. For example, a user can be given the ability to explicitly run a utility that reassigns older history blocks from a given file back to the same file at a later time, for erasure and reuse. Thus, the ability for ransomware to attack multiple files can be reduced as histories for individual files remain separate. By keeping histories separate, an attack on one file does not spill over into reclaiming older blocks that were previously mapped for a different purpose.

In one embodiment, system 400 supports priority information for LBAs. Thus, for example, system 400 may enable a user or the host system to specify priority of LBAs. In one embodiment, system 400 factors in priority information, and can, for example, overwrite the history of low-priority LBAs when space is needed prior to overwriting higher-priority data. Priority consideration can be applied to prioritize longer histories of filesystem metadata and critical user files, for example. In one embodiment, the nonvolatile storage is subject to a policy or configuration that allows the selection of priority of files. Configuration can include configuration information stored in the host to manage the operation of the nonvolatile storage. The policy can refer to an algorithm or routine or service within the storage controller that considers priority information for the reclamation of storage space. In one embodiment, system 400 includes analytics to allow the system to assign priority to certain files.

In one embodiment, the storage controller of system 400 can identify files or data based on frequency of access or other parameter as priority data. The system can determine based on usability or other parameters what data should be prevented from garbage collection. The system can determine which files are important or priority from others based on these parameters. The system can determine the importance of files by application of a learning mechanism, such as a machine learning algorithm. In one embodiment, application of a learning mechanism based on the file usages, the system can perform automatic prioritization.

In one embodiment, system 400 exposes access interfaces for the host to query and receive information about the checkpointing data. In one embodiment, the host supports commands to query ledger 430 for data. Based on the queries, the host can be configured to provide more sophisticated analyses or applications with the data. For example, the host may be able to determine write histories and trends, as well as version information and information about the sources of write activity, or other analysis, or a combination.

Referring to the specific example illustrated in system 400, consider a very simplified example for purposes of illustration. Assume system 400 illustrates information for an SSD with 4 EUs that contain 8 pages each. The SSD exposes a capacity of 16 LBAs to the user, with a rollback capability (S) of 5 sector-writes. In an initial condition, consider that the SSD is started completely blank, and the writes are issued as listed in host writes 420. EU1 is written first, followed by EU3. At that point, the system has not performed any defrags. Given the host writes as listed, the entries in L2P 410 and ledger 430 are as listed. Note that even though ledger 430 only includes four entries, the system has a rollback capability of 5, since sector 14 can be rolled back to an empty physical address based on an absent ledger corresponding to LBA14. Thus, in one embodiment, when a write is indicated in a list or table, and a log or ledger does not include an entry for the LBA, in one embodiment, the system rolls it back to empty. Other writes will be rolled back to their previous states.

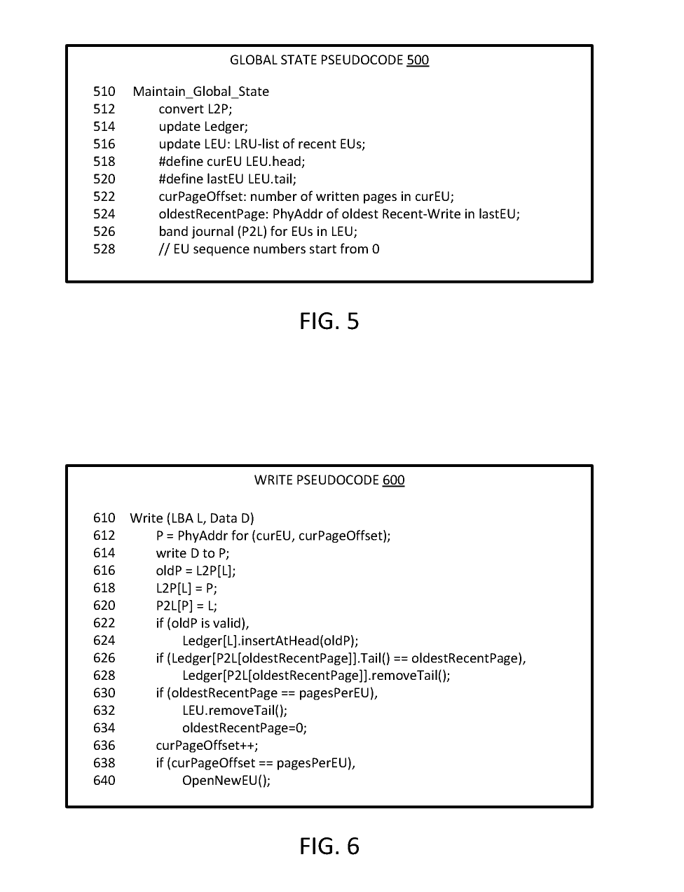

FIG. 5 is a diagrammatic representation of an embodiment of pseudocode for maintaining global state in a checkpointing ledger. Global state pseudocode 500 provides an example of a function to maintain global state at line 510. Pseudocode 500 can be executed by a checkpointing engine in accordance with an embodiment described herein. At line 512, the function converts a logical to physical address for the write operation. At line 514, in one embodiment, the function updates a write ledger to log the write information. At line 516, the function updates the ledger erase unit information, which can be considered an LRU list of recent EUs.

At line 518, the function defines a current erase unit (curEU) as the erase unit at the head of an EU list. At line 520, the function can define a last erase unit (lastEU) as the erase unit at the tail or the end of the EU list. In one embodiment, at line 522, the current page offset is the number of written pages in the current EU. In one embodiment, in line 524, the oldest recent page is the physical address of the oldest recent-write in the lastEU.

In one embodiment, at line 526, the function performs bandjournaling, converting the physical address to logical address for EUs in the list of EUs. In one embodiment, the EU sequence number starts at 0, as indicated in the comment of line 528. In the example of pseudocode 500, maintenance of sequence numbers is not illustrated for brevity. It will be understood that pseudocode 500 can include operations to maintain the sequence numbers for the EUs.

FIG. 6 is a diagrammatic representation of an embodiment of pseudocode for writing a page in a checkpointing environment. Write pseudocode 600 provides an example of write algorithm operations for checkpointing. Pseudocode 600 can be executed by a checkpointing engine in accordance with an embodiment described herein. The write function begins at line 610, and receives a logical address and data to write to the logical address. At line 612, the function identifies P as the physical address for the current EU at the current page offset. The physical address identified is a location to write the data, and represents an available storage location. At line 614, the function writes the data to the physical address.

A typical write function performs the write operation and can end. Pseudocode 600 includes operations related to continuous checkpointing. In one embodiment, at line 616, the function sets an oldP or old physical address equal to the logical to physical address of the received logical address L. Thus, the previous address associated with the logical address becomes the former address for the stale data. In one embodiment, the function cross-relates the physical and logical addresses with separate lists. For example, at line 618 the function sets an L2P entry for L (the logical address) equal to the physical address of P, and at line 620 sets a P2L entry for P equal to L.

At line 622, in one embodiment, the function provides a condition operation as illustrated by the if statement. If oldP is valid, at line 624, the function inserts the address at the head of the list of addresses in a ledger. At line 626, the function determines if the tail for a sequence or string of entries for the logical address is the oldest recent page. In one embodiment, if the tail entry is the oldest recent page or the oldest page within the rollback capability, the function removes the tail at line 628. Such an operation keeps the number of EUs within the configured range of rollback capability.

In one embodiment, at line 630, the function determines if the oldest recent page is equal to the pages in the EU. If it is, in one embodiment, at line 632, the function removes the last EU in the list of EUs, and at line 634, resets the oldest recent page. In one embodiment, at line 636, the function increments the current page offset, and determines at line 638 if the current page offset is equal to the pages in the EU. If the statement is true, the function can open a new EU at line 640.

In one embodiment, pseudocode 600 represents a modified write algorithm for a checkpointing engine in a storage controller. A write algorithm traditionally selects a physical page and executes the write to transfer the data to the nonvolatile media. Instead of simply executing the write as with a traditional write algorithm, in one embodiment, write algorithm of pseudocode 600 enables the checkpointing engine to update a ledger as well. In one embodiment, for the LBA being updated, the older L2P entry is written to the ledger (if valid). The oldest recent-write can be removed from the ledger if present. It will be understood that L can represent an address for a write of new data, or an address for a modification of data already stored on the nonvolatile storage medium.

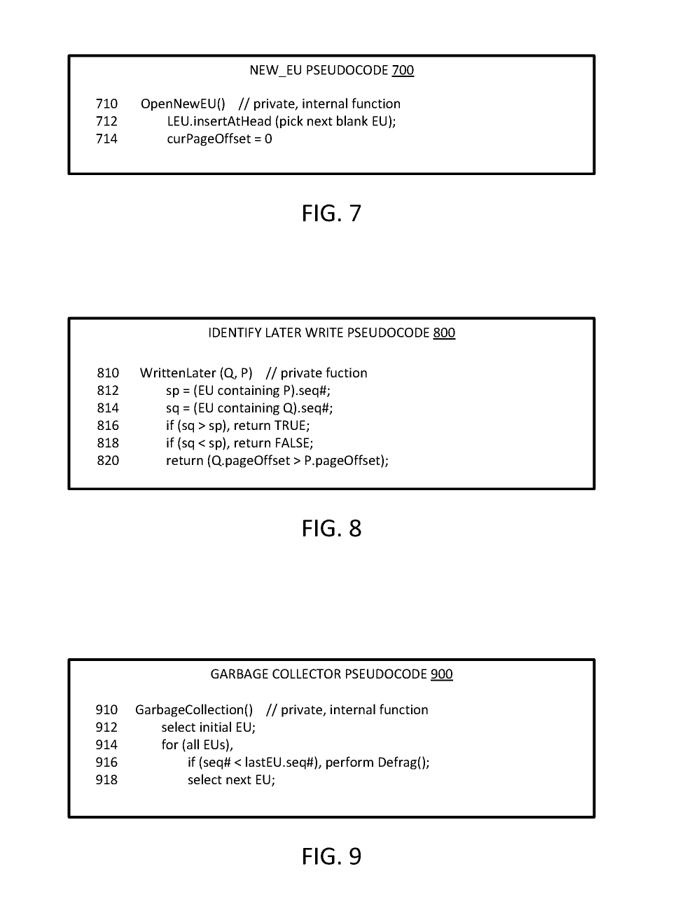

FIG. 7 is a diagrammatic representation of an embodiment of pseudocode for creating an erase unit in a checkpointing environment. New EU pseudocode 700 provides an example of a function to create a new erase unit at line 710. Pseudocode 700 can be executed by a checkpointing engine in accordance with an embodiment described herein. In one embodiment, the function is a private, internal function only, which is not exposed for use by a function outside the checkpointing engine.

At line 712, the function selects the next blank or available EU, and inserts the EU at the head of a list or string of linked EUs. In one embodiment, at line 714, as part of selecting a new EU, the function resets the current page offset to zero, as the new EU does not have any written pages yet.

FIG. 8 is a diagrammatic representation of an embodiment of pseudocode for identifying write order in a checkpointing environment. Pseudocode 800 for identifying a later write provides an example of a function at line 810 to determine if an EU is older than another EU. Pseudocode 800 can be executed by a checkpointing engine in accordance with an embodiment described herein. In one embodiment, the function is private, and is not exposed for use by a function outside of the checkpointing engine.

In one embodiment, the function receives inputs Q and P as EUs to compare. At line 812, the function sets a sequence of P (sp) equal to the sequence number of the EU containing P, and at line 814 sets a sequence of Q (sq) equal to the sequence number of the EU containing Q. At line 816 the function provides conditional operation, and returns TURE or logic high if sq is greater than sp. At line 818, the function returns FALSE or logic low if it determines that sq is less than sp. In one embodiment, the function can return the result of a comparison of whether the page offset for Q is greater than the page offset for P), at line 820.

FIG. 9 is a diagrammatic representation of an embodiment of pseudocode for garbage collection in a checkpointing environment. Garbage collector pseudocode 900 provides an example of a function for garbage collection at line 910. Pseudocode 900 can be executed by a checkpointing engine in accordance with an embodiment described herein. In one embodiment, the function is a private, internal function that is not exposed for use by a function outside the checkpointing engine.

At line 912, the function can select an initial EU. At line 914, the function can enter a for loop that will continue for all EUs. At line 916, in one embodiment, if the sequence number of the EU is less than the sequence number of the last EU, then at line 918 the function can perform a defrag function. In one embodiment, the defrag function can be any known or custom defrag function. The if statement can ensure that EUs containing recent writes are not selected for defrag. In one embodiment, any EU other than a recent write EU can be selected for garbage collection per policies understood in the art, such as based on validity count, staleness, or other metric, or a combination. In one embodiment, the function of pseudocode 900 can exclude the recent writes by maintaining a sequence number per EU and checking to ensure that that number is lower than the sequence number of the EU corresponding to the oldest recent write.

The selective defrag operation ends at line 920, and the function selects the next EU for inspection at line 918 after the selective defrag. The function can continue the for loop until there are no more EUs.

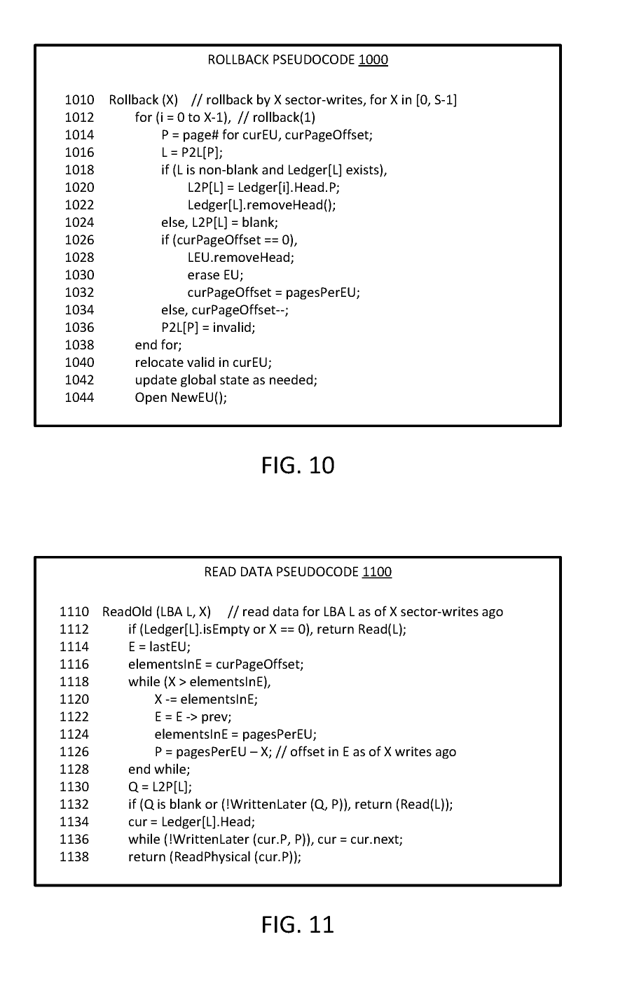

FIG. 10 is a diagrammatic representation of an embodiment of pseudocode for rollback based on continuous checkpointing. Rollback pseudocode 1000 provides an example of a function to perform rollback at line 1010. Pseudocode 1000 can be executed by a checkpointing engine in accordance with an embodiment described herein. In one embodiment, pseudocode 1000 is specific to rollback based on a number of sector writes. It will be understood that the function can be configured to roll back based on time, or a combination of time and number of writes. In one embodiment, a higher level function determines a number of writes that are needed to roll back to implement a rollback for an amount of time or for a total amount of storage, and calls the function with an indication of the number of writes.

In one embodiment, the function takes as input a number X to indicate a number of writes to roll back or undo. It will be understood that for a rollback of X writes, the value of X should be constrained to within a range of S which indicates a total rollback capability of the system.

At line 1012, the function enters a for loop, where each pass through the for loop rolls back one of the X writes. Thus, the function will loop X times. At line 1014, P is set as a page number for the current EU having a current page offset. At line 1016, the function sets the logical address Las the logical address associated with P. In one embodiment, at line 1018, the function provides for conditional operation, where if L is non-blank or not empty and a ledger entry exists for L, the function will perform specified operations. At line 1020, the function sets the L2P entry for L to the ledger at the head at address P. The function at line 1022 can remove the head from the ledger, as the head has been moved by the rollback of the write operation. It will be understood that rolling back the write includes changing the logical and physical address association to a previous physical address P, and to remove the head of a list of operations to that the data associated with the rolled back operation is no longer associated with the logical address.

At line 1024, another conditional operation occurs if the if statement is not true, as illustrated by the else statement alternative. The function can associate blank or null data with the logical address. In one embodiment, if a logical address has no ledger entry associated with it, it is because it is a new write, and the logical address was blank prior to the write. Thus, rolling back the write includes resetting the logical address to a blank state.

In one embodiment, at line 1026, the function conditionally executes other operations if the current page offset is zero, which indicates that the EU is empty. If the offset is zero, in one embodiment, at line 1028, the function removes the head of the EU list. At line 1030, the function erases the empty EU. At line 1032, the function sets the current page offset to the number of pages in an EU. In one embodiment, if the current page offset is not zero, the function can execute an “else”-based conditional operation to decrement the current page offset.

In one embodiment, at line 1036, the function sets the P2L data for the physical address as invalid, since the data has been rolled back and is no longer valid data. The for loop ends at line 1038, and the subsequent time through, the current page offset will be one lower, and a write transaction one earlier in time will be rolled back. In one embodiment, the function relocates valid data in the current EU after the for loop at line 1040. In one embodiment, the function updates the global state information as needed at line 1042. In one embodiment, the function opens a new EU at line 1044.

The function of pseudocode 1000 can provide for rolling back the state of a nonvolatile storage, using the state maintained for the storage. The rollback function can iteratively move state one write at a time. In one embodiment, for a given last write being rolled back, its most-recent (first) ledger entry, as needed, is placed into the L2P and removed from the ledger. After each individual rollback, in one embodiment, the pages invalidated as a result of the rollbacks are erased. Erasing the invalidated pages can occur after garbage-collecting any valid data in the affected EUs. In one embodiment, an interface to expose the rollback function is standardized for all nonvolatile storage. In one embodiment, the interface to expose the rollback function can be a vendor-specific command.

FIG. 11 is a diagrammatic representation of an embodiment of pseudocode for reading old data without rollback based on continuous checkpointing. Read stale data pseudocode 1100 provides an example of a function to read old or previous state at line 1110. Pseudocode 1100 can be executed by a checkpointing engine in accordance with an embodiment described herein. Pseudocode 1100 enables a system to read the data or the system state by reading data for a logical address as of X sector writes previously in time. In contrast to pseudocode 1000 described above, the function of pseudocode 1100 only reads the data without rolling the state back. In one embodiment, the function receives input parameters of logical address LBA L and a number X of sector writes to look back for read data.

In one embodiment, the prior read capability of the ReadOld function can be simpler and faster than the Rollback function, such as what is described above with respect to pseudocode 1000. In one embodiment, to read data at LBA L as it was X SSD-writes ago, the function can calculate the EU and page that was written X writes ago. After computing that EU and page, the system can use the L2P entry for the logical address, and the ledger information for the logical address, to determine the latest physical-address corresponding to the logical address that was before that EU and page. The system can read and return the user data at that physical page.

At line 1112, the function can conditionally return the data of the current state of L if there are no entries in a ledger for L, or if the number of sector writes specified is zero. In one embodiment, at line 1114, the function sets E equal to the last EU. The function can set the number of elements in E (elementslnE) equal to the current page offset or the number of pages in the EU, at line 1116.

In one embodiment, the function incudes a while loop starting at line 1118, which loops as long as X is higher than the number of elements in the EU. At line 1120, the function subtracts elementslnE from X, and assigns the computed value to X. At line 1122, the function sets E to a previous EU. At line 1124, the function sets elementslnE to the number of pages per EU. At line 1126, the function sets P equal to the pages per EU minus X, which indicates the page offset in E as of X writes ago. The while loop ends at line 1128, and the function determines to loop through again or continue.

At line 1130, the function can set Q equal to the entry in a logical to physical mapping table. At line 1132, the function can conditionally return a read of the logical address if Q is blank or if Q is not written later than a current physical address P. If Q is blank, then it is a new read and does not have history. If Q is not written later than P, it does not reflect the next write in the history. In either case, the logical address represents the most distant data than can be read within the rollback capability of the system.

The function can set a current variable cur to the head of a ledger at line 1134. In one embodiment, the function can execute a while function at line 1136 to find a next physical address P that represents a next prior write, but setting cur to the next current value for as long as cur.P is not written later than P. The function can return the data read by a physical address read of the eventual cur.P that is found, at line 1138.

In one embodiment, a system performs rollback by a ReadOld and Write sequence, such as executing the function of pseudocode 1100 to read the prior or stale data, and then executing the function of pseudocode 1000 to write the data as the current state. The ReadOld sequence refers to a capability of the system to read stale data states based on checkpointing. Thus, the host may read the old value and perform a write operation. With such operation, the system can maintain the history of writes. Such an approach can be used to maintain history of writes while still rolling-back, for example, for debug or other applications.

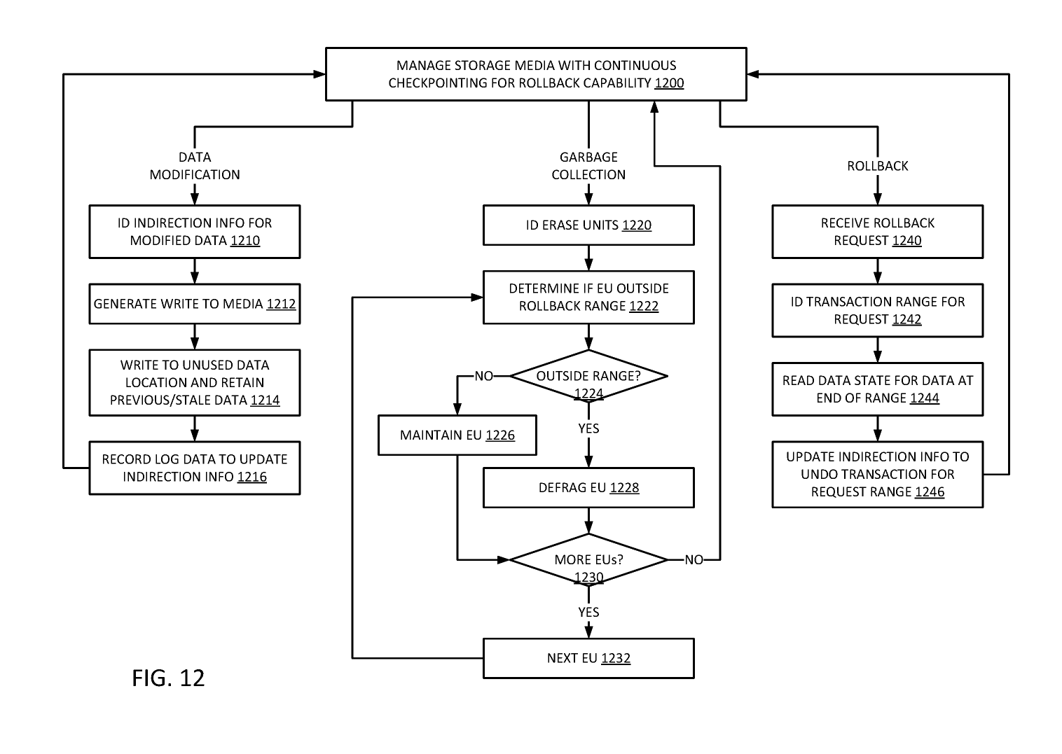

FIG. 12 is a flow diagram of an embodiment of operations for continuous checkpointing. Processes 1200 represent processes for managing storage media with continuous checkpointing for rollback capability. Processes 1200 can be implemented by a checkpointing engine or storage controller or a combination, in accordance with an embodiment described herein. In one embodiment, in response to a data modification, a checkpointing engine or comparable logic can identify indirection information for the modified data, 1210. It will be understood that data modification can refer to a modification of data already stored in a nonvolatile storage, or to a write of new data to nonvolatile storage. The indirection information can be or include logical to physical address information. The indirection enables identification of the physical address to write the data.

To write the data, the storage controller generates a write to the nonvolatile media, 1212. The storage controller performs write to unused storage locations, which enables the system to maintain stale data for rollback or read. Thus, the storage controller writes to an unused data location and retains the previous or stale data, 1214. It can be stated that the system maintains prior data state, which refers not only to the preservation of the stale data, but the indirection information needed to access the data and track how to roll it back. In one embodiment, the checkpointing engine, which can be implemented by the storage controller, records log or ledger data to update the indirection information, 1216. The log data tracks prior address information for the modified data, or indicates that the write is new data and the previous data state was null. The recording on each write transaction can be referred to as continuous checkpointing.

As a separate, and potentially parallel process to write, the system can implement a background garbage collection process. For garbage collection, in one embodiment, the checkpointing engine identifies erase units, 1220. Erase units can refer to locations that are not currently pointed to be logical addresses or current indirection information. Thus, they can refer to nonvolatile storage locations where data has been stored, but the data is not currently considered valid by the system.

In one embodiment, the checkpointing engine determines if the EU is outside the rollback range or the rollback capability for the system, 1222. The rollback range can refer to any rollback capability as described herein. If the EU is not outside the range of rollback capability, 1224 NO branch, the garbage collector does not reclaim the EU, but maintains the EU, 1226. If the EU is outside the range of rollback capability, 1224 YES branch, the garbage collector reclaims or defrags the EU, 1228. Thus, the garbage collector can operate to only reclaim storage locations once they are too old or too many writes back to be within the range of rollback capability. After evaluating an EU for defrag, the garbage collector can determine if there are more EUs to evaluate. If there is another EU, 1230 YES branch, the garbage collector can identify the next EU, 1232, and repeat the process starting with 1222. If there are no more EUs to evaluate, 1230, the garbage collection process can end and the system will continue to manage the storage.

The checkpointing engine supports rollback to a prior data state. For rollback, in one embodiment, the checkpointing engine receives a rollback request, 1240. The rollback request can be initiated by a user or another process in the system. For purposes of process 1200, the rollback can include reading without changing the current data state. For rollback, the checkpointing engine can identify a transaction range for the request, 1242. The transaction range identifies either an amount of data to roll back, an amount of time to roll back, or a number of transactions to roll back. In one embodiment, the checkpointing engine identifies a number of write transactions to roll back to satisfy the timing or data amount of a request, such as any state X indicated within a range of 1 to N writes ago. The indirection engine reads the data state for the data at the end of the transaction range, 1244. The data at the end of the transaction range refers to the state of data as it was for how far back the user would like to read or roll back. If the system only reads the data, the read old data process ends at 1244. If the system is rolling back the data state, the checkpointing engine can update indirection information to undo the transactions for the requested range, 1246. In either case, the process returns to the management routine.

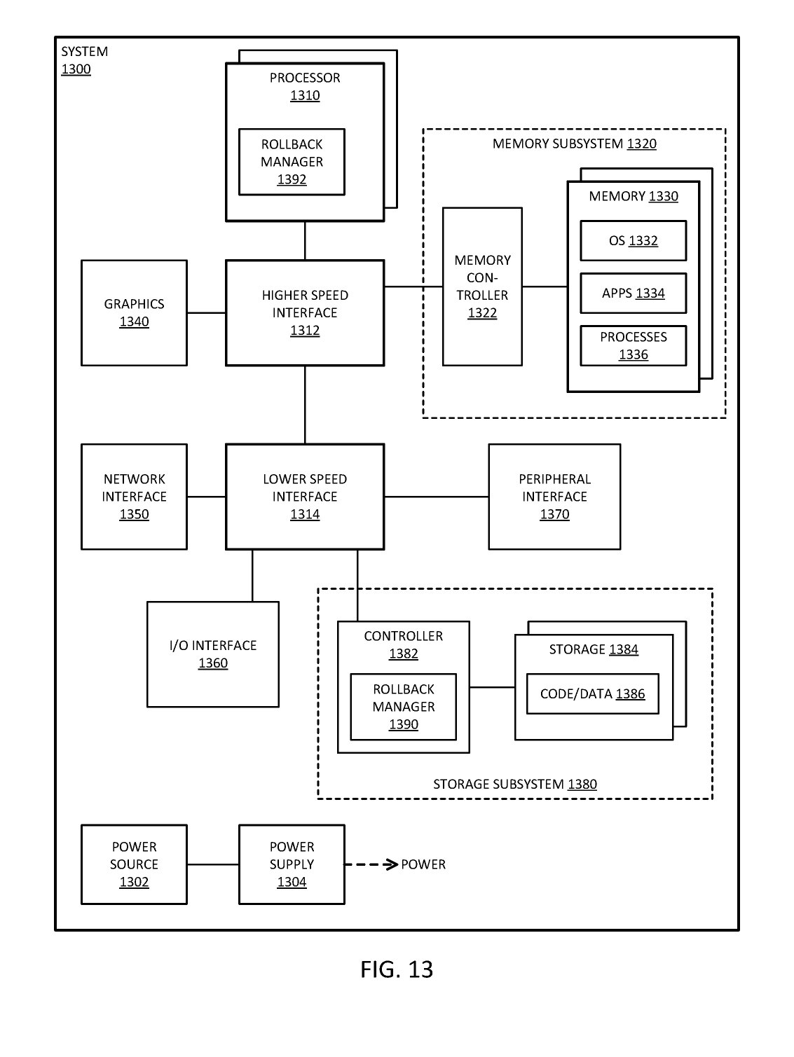

FIG. 13 is a block diagram of an embodiment of a computing system in which continuous checkpointing can be implemented. System 1300 represents a computing device in accordance with any embodiment described herein, and can be a laptop computer, a desktop computer, a tablet computer, a server, a gaming or entertainment control system, a scanner, copier, printer, routing or switching device, embedded computing device, a smartphone, a wearable device, an internet-of-things device or other electronic device.

System 1300 includes processor 1310, which provides processing, operation management, and execution of instructions for system 1300. Processor 1310 can include any type of microprocessor, central processing unit (CPU), graphics processing unit (GPU), processing core, or other processing hardware to provide processing for system 1300, or a combination of processors. Processor 1310 controls the overall operation of system 1300, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one embodiment, system 1300 includes interface 1312 coupled to processor 1310, which can represent a higher speed interface or a high throughput interface for system components that needs higher bandwidth connections, such as memory subsystem 1320 or graphics interface components 1340. Interface 1312 represents an interface circuit which can be a standalone component or integrated onto a processor die. Where present, graphics interface 1340 interfaces to graphics components for providing a visual display to a user of system 1300. In one embodiment, graphics interface 1340 can drive a high definition (HD) display that provides an output to a user. High definition can refer to a display having a pixel density of approximately 100 PPI (pixels per inch) or greater, and can include formats such as full HD (e.g., 1080 p), retina displays, 4K (ultra high definition or UHD), or others. In one embodiment, the display can include a touchscreen display. In one embodiment, graphics interface 1340 generates a display based on data stored in memory 1330 or based on operations executed by processor 1310 or both. In one embodiment, graphics interface 1340 generates a display based on data stored in memory 1330 or based on operations executed by processor 1310 or both.

Memory subsystem 1320 represents the main memory of system 1300, and provides storage for code to be executed by processor 1310, or data values to be used in executing a routine. Memory subsystem 1320 can include one or more memory devices 1330 such as read-only memory (ROM), flash memory, one or more varieties of random access memory (RAM) such as DRAM, or other memory devices, or a combination of such devices. Memory 1330 stores and hosts, among other things, operating system (OS) 1332 to provide a software platform for execution of instructions in system 1300. Additionally, applications 1334 can execute on the software platform of OS 1332 from memory 1330. Applications 1334 represent programs that have their own operational logic to perform execution of one or more functions. Processes 1336 represent agents or routines that provide auxiliary functions to OS 1332 or one or more applications 1334 or a combination. OS 1332, applications 1334, and processes 1336 provide software logic to provide functions for system 1300. In one embodiment, memory subsystem 1320 includes memory controller 1322, which is a memory controller to generate and issue commands to memory 1330. It will be understood that memory controller 1322 could be a physical part of processor 1310 or a physical part of interface 1312. For example, memory controller 1322 can be an integrated memory controller, integrated onto a circuit with processor 1310.

While not specifically illustrated, it will be understood that system 1300 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus.

In one embodiment, system 1300 includes interface 1314, which can be coupled to interface 1312. Interface 1314 can be a lower speed interface than interface 1312. In one embodiment, interface 1314 represents an interface circuit, which can include standalone components and integrated circuitry. In one embodiment, multiple user interface components or peripheral components, or both, couple to interface 1314. Network interface 1350 provides system 1300 the ability to communicate with remote devices (e.g., servers or other computing devices) over one or more networks. Network interface 1350 can include an Ethernet adapter, wireless interconnection components, cellular network interconnection components, USB (universal serial bus), or other wired or wireless standards-based or proprietary interfaces. Network interface 1350 can exchange data with a remote device, which can include sending data stored in memory or receiving data to be stored in memory.

In one embodiment, system 1300 includes one or more input/output (I/O) interface(s) 1360. I/O interface 1360 can include one or more interface components through which a user interacts with system 1300 (e.g., audio, alphanumeric, tactile/touch, or other interfacing). Peripheral interface 1370 can include any hardware interface not specifically mentioned above. Peripherals refer generally to devices that connect dependently to system 1300. A dependent connection is one where system 1300 provides the software platform or hardware platform or both on which operation executes, and with which a user interacts.

In one embodiment, system 1300 includes storage subsystem 1380 to store data in a nonvolatile manner. In one embodiment, in certain system implementations, at least certain components of storage 1380 can overlap with components of memory subsystem 1320. Storage subsystem 1380 includes storage device(s) 1384, which can be or include any conventional medium for storing large amounts of data in a nonvolatile manner, such as one or more magnetic, solid state, or optical based disks, or a combination. Storage 1384 holds code or instructions and data 1386 in a persistent state (i.e., the value is retained despite interruption of power to system 1300). Storage 1384 can be generically considered to be a “memory,” although memory 1330 is typically the executing or operating memory to provide instructions to processor 1310. Whereas storage 1384 is nonvolatile, memory 1330 can include volatile memory (i.e., the value or state of the data is indeterminate if power is interrupted to system 1300). In one embodiment, storage subsystem 1380 includes controller 1382 to interface with storage 1384. In one embodiment controller 1382 is a physical part of interface 1314 or processor 1310, or can include circuits or logic in both processor 1310 and interface 1314.

Power source 1302 provides power to the components of system 1300. More specifically, power source 1302 typically interfaces to one or multiple power supplies 1304 in system 1302 to provide power to the components of system 1300. In one embodiment, power supply 1304 includes an AC to DC (alternating current to direct current) adapter to plug into a wall outlet. Such AC power can be renewable energy (e.g., solar power) power source 1302. In one embodiment, power source 1302 includes a DC power source, such as an external AC to DC converter. In one embodiment, power source 1302 or power supply 1304 includes wireless charging hardware to charge via proximity to a charging field. In one embodiment, power source 1302 can include an internal battery or fuel cell source.

In one embodiment, system 1300 includes rollback manager 1390, which represents logic to perform checkpointing according to any embodiment described herein. Rollback manager 1390 represents components within the storage system to implement the checkpointing and rollback capabilities. In accordance with what is described herein, rollback manager 1390 can be implemented in a storage controller. In one embodiment, the storage controller is the storage controller within the storage device such as an SSD. In one embodiment, the storage controller is the storage controller within the hardware platform of system 1300. Rollback manager 1390 enables system 1300 to perform continuous checkpointing of writes, and read or roll back to any storage point up to a configurable amount of rollback capability. Rollback manager 1392 represents operations executed within processor 1310 to perform checkpointing or rollback within system 1300.

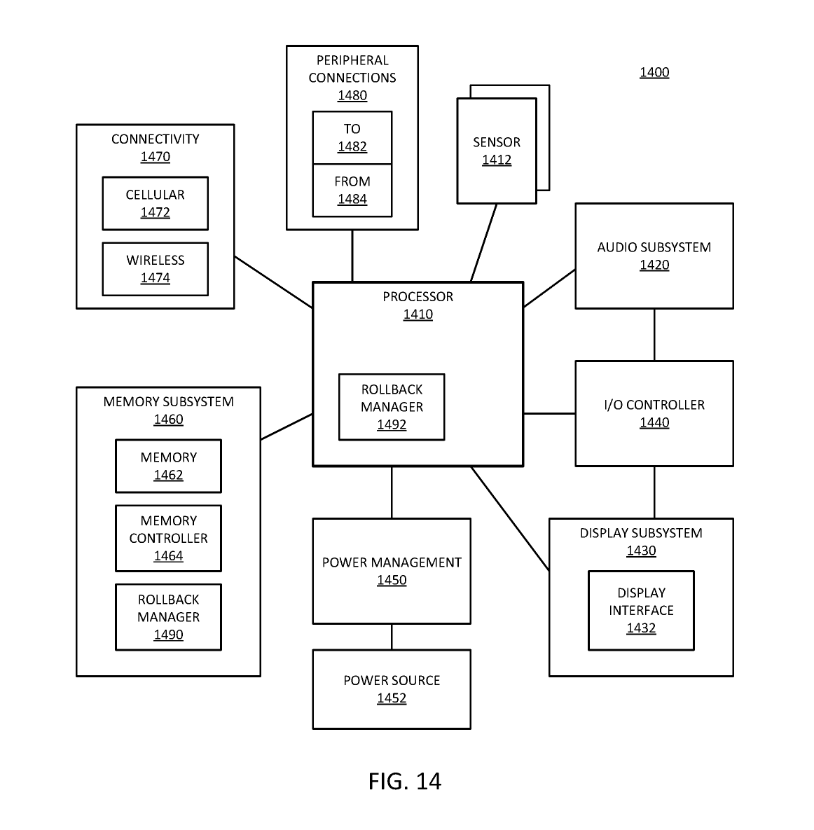

FIG. 14 is a block diagram of an embodiment of a mobile device in which continuous checkpointing can be implemented. Device 1400 represents a mobile computing device, such as a computing tablet, a mobile phone or smartphone, a wireless-enabled e-reader, wearable computing device, an internet-of-things device or other mobile device, or an embedded computing device. It will be understood that certain of the components are shown generally, and not all components of such a device are shown in device 1400.

Device 1400 includes processor 1410, which performs the primary processing operations of device 1400. Processor 1410 can include one or more physical devices, such as microprocessors, application processors, microcontrollers, programmable logic devices, or other processing means. The processing operations performed by processor 1410 include the execution of an operating platform or operating system on which applications and device functions are executed. The processing operations include operations related to I/O (input/output) with a human user or with other devices, operations related to power management, operations related to connecting device 1400 to another device, or a combination. The processing operations can also include operations related to audio I/O, display I/O, or other interfacing, or a combination. Processor 1410 can execute data stored in memory. Processor 1410 can write or edit data stored in memory.

In one embodiment, system 1400 includes one or more sensors 1412. Sensors 1412 represent embedded sensors or interfaces to external sensors, or a combination. Sensors 1412 enable system 1400 to monitor or detect one or more conditions of an environment or a device in which system 1400 is implemented. Sensors 1412 can include environmental sensors (such as temperature sensors, motion detectors, light detectors, cameras, chemical sensors (e.g., carbon monoxide, carbon dioxide, or other chemical sensors)), pressure sensors, accelerometers, gyroscopes, medical or physiology sensors (e.g., biosensors, heart rate monitors, or other sensors to detect physiological attributes), or other sensors, or a combination. Sensors 1412 can also include sensors for biometric systems such as fingerprint recognition systems, face detection or recognition systems, or other systems that detect or recognize user features. Sensors 1412 should be understood broadly, and not limiting on the many different types of sensors that could be implemented with system 1400. In one embodiment, one or more sensors 1412 couples to processor 1410 via a frontend circuit integrated with processor 1410. In one embodiment, one or more sensors 1412 couples to processor 1410 via another component of system 1400.

In one embodiment, device 1400 includes audio subsystem 1420, which represents hardware (e.g., audio hardware and audio circuits) and software (e.g., drivers, codecs) components associated with providing audio functions to the computing device. Audio functions can include speaker or headphone output, as well as microphone input. Devices for such functions can be integrated into device 1400, or connected to device 1400. In one embodiment, a user interacts with device 1400 by providing audio commands that are received and processed by processor 1410.

Display subsystem 1430 represents hardware (e.g., display devices) and software components (e.g., drivers) that provide a visual display for presentation to a user. In one embodiment, the display includes tactile components or touchscreen elements for a user to interact with the computing device. Display subsystem 1430 includes display interface 1432, which includes the particular screen or hardware device used to provide a display to a user. In one embodiment, display interface 1432 includes logic separate from processor 1410 (such as a graphics processor) to perform at least some processing related to the display. In one embodiment, display subsystem 1430 includes a touchscreen device that provides both output and input to a user. In one embodiment, display subsystem 1430 includes a high definition (HD) display that provides an output to a user. High definition can refer to a display having a pixel density of approximately 100 PPI (pixels per inch) or greater, and can include formats such as full HD (e.g., 1080 p), retina displays, 4K (ultra high definition or UHD), or others. In one embodiment, display subsystem includes a touchscreen display. In one embodiment, display subsystem 1430 generates display information based on data stored in memory or based on operations executed by processor 1410 or both.

I/O controller 1440 represents hardware devices and software components related to interaction with a user. I/O controller 1440 can operate to manage hardware that is part of audio subsystem 1420, or display subsystem 1430, or both. Additionally, I/O controller 1440 illustrates a connection point for additional devices that connect to device 1400 through which a user might interact with the system. For example, devices that can be attached to device 1400 might include microphone devices, speaker or stereo systems, video systems or other display device, keyboard or keypad devices, or other I/O devices for use with specific applications such as card readers or other devices.

As mentioned above, I/O controller 1440 can interact with audio subsystem 1420 or display subsystem 1430 or both. For example, input through a microphone or other audio device can provide input or commands for one or more applications or functions of device 1400. Additionally, audio output can be provided instead of or in addition to display output. In another example, if display subsystem includes a touchscreen, the display device also acts as an input device, which can be at least partially managed by I/O controller 1440. There can also be additional buttons or switches on device 1400 to provide I/O functions managed by I/O controller 1440.

In one embodiment, I/O controller 1440 manages devices such as accelerometers, cameras, light sensors or other environmental sensors, gyroscopes, global positioning system (GPS), or other hardware that can be included in device 1400, or sensors 1412. The input can be part of direct user interaction, as well as providing environmental input to the system to influence its operations (such as filtering for noise, adjusting displays for brightness detection, applying a flash for a camera, or other features).

In one embodiment, device 1400 includes power management 1450 that manages battery power usage, charging of the battery, and features related to power saving operation. Power management 1450 manages power from power source 1452, which provides power to the components of system 1400. In one embodiment, power source 1452 includes an AC to DC (alternating current to direct current) adapter to plug into a wall outlet. Such AC power can be renewable energy (e.g., solar power, motion based power). In one embodiment, power source 1452 includes only DC power, which can be provided by a DC power source, such as an external AC to DC converter. In one embodiment, power source 1452 includes wireless charging hardware to charge via proximity to a charging field. In one embodiment, power source 1452 can include an internal battery or fuel cell source.

Memory subsystem 1460 includes memory device(s) 1462 for storing information in device 1400. Memory subsystem 1460 can include nonvolatile (state does not change if power to the memory device is interrupted) or volatile (state is indeterminate if power to the memory device is interrupted) memory devices, or a combination. Memory 1460 can store application data, user data, music, photos, documents, or other data, as well as system data (whether long-term or temporary) related to the execution of the applications and functions of system 1400. In one embodiment, memory subsystem 1460 includes memory controller 1464 (which could also be considered part of the control of system 1400, and could potentially be considered part of processor 1410). Memory controller 1464 includes a scheduler to generate and issue commands to control access to memory device 1462.

Connectivity 1470 includes hardware devices (e.g., wireless or wired connectors and communication hardware, or a combination of wired and wireless hardware) and software components (e.g., drivers, protocol stacks) to enable device 1400 to communicate with external devices. The external device could be separate devices, such as other computing devices, wireless access points or base stations, as well as peripherals such as headsets, printers, or other devices. In one embodiment, system 1400 exchanges data with an external device for storage in memory or for display on a display device. The exchanged data can include data to be stored in memory, or data already stored in memory, to read, write, or edit data.

Connectivity 1470 can include multiple different types of connectivity. To generalize, device 1400 is illustrated with cellular connectivity 1472 and wireless connectivity 1474. Cellular connectivity 1472 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4 G”), or other cellular service standards. Wireless connectivity 1474 refers to wireless connectivity that is not cellular, and can include personal area networks (such as Bluetooth), local area networks (such as WiFi), or wide area networks (such as WiMax), or other wireless communication, or a combination. Wireless communication refers to transfer of data through the use of modulated electromagnetic radiation through a non-solid medium. Wired communication occurs through a solid communication medium.

Peripheral connections 1480 include hardware interfaces and connectors, as well as software components (e.g., drivers, protocol stacks) to make peripheral connections. It will be understood that device 1400 could both be a peripheral device (“to” 1482) to other computing devices, as well as have peripheral devices (“from” 1484) connected to it. Device 1400 commonly has a “docking” connector to connect to other computing devices for purposes such as managing (e.g., downloading, uploading, changing, synchronizing) content on device 1400. Additionally, a docking connector can allow device 1400 to connect to certain peripherals that allow device 1400 to control content output, for example, to audiovisual or other systems.

In addition to a proprietary docking connector or other proprietary connection hardware, device 1400 can make peripheral connections 1480 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), or other type.

In one embodiment, system 1400 includes rollback manager 1490, which represents logic to perform checkpointing according to any embodiment described herein. Rollback manager 1490 represents components within the storage system to implement the checkpointing and rollback capabilities. In accordance with what is described herein, rollback manager 1490 can be implemented in a storage controller. In one embodiment, the storage controller is the storage controller within the storage device such as an SSD. In one embodiment, the storage controller is the storage controller within the hardware platform of system 1400. Rollback manager 1490 enables system 1400 to perform continuous checkpointing of writes, and read or roll back to any storage point up to a configurable amount of rollback capability. Rollback manager 1492 represents operations executed within processor 1410 to perform checkpointing or rollback within system 1400.

In one aspect, an apparatus to interface with storage resources includes: a hardware interface to couple to a nonvolatile storage medium; and a controller to translate logical addresses to physical addresses for writes to the nonvolatile storage medium, wherein the controller is to maintain a log of a most recent N writes, wherein N represents a configurable amount of data, and wherein the controller is to write data to unused physical addresses as active data, and maintain stale data for the most recent N writes.

In one embodiment, N indicates a number of writes that occur within a time period. In one embodiment, N indicates a number of writes that represent an amount of storage capacity. In one embodiment, the controller is to expose an application data interface to allow changing an active state of the nonvolatile storage medium back to anywhere from 1 to N writes ago. In one embodiment, the controller is to expose an application data interface to allow reading a state of the nonvolatile storage medium back to anywhere from 1 to N writes ago without changing an active state of the nonvolatile storage medium. In one embodiment, N comprises a user-selected setting to indicate a rollback capability. In one embodiment, maintain the stale data comprises the controller to prevent garbage collection or defragmentation. In one embodiment, the log comprises entries to indicate a logical block address and one or more physical addresses associated with stale data. In one embodiment, the write comprises a modification of data already stored on the nonvolatile storage medium. In one embodiment, the nonvolatile storage medium comprises flash memory. In one embodiment, the nonvolatile storage medium comprises either a hard disk drive or a serial peripheral interface storage device. In one embodiment, the controller comprises a controller on a solid state drive (SSD). In one embodiment, the controller comprises a controller on a host separate from a solid state drive. In one embodiment, the controller is further to receive a rollback request as a secured command, and is to execute the rollback request only after verification of the secured command. In one embodiment, the controller is further to maintain the log based at least in part on priority of the data, wherein data associated with a logical address identified as priority data is to be maintained in the log ahead of data having a lower priority. In one embodiment, the controller is further to maintain the log based at least in part on priority of the data, wherein the controller is to automatically prioritize data based on file usage.

In one aspect, a computer system includes: a host processor; a nonvolatile storage device to store data processed by the host processor, wherein the storage device is to write modifications to data to unused physical addresses as active data; and a controller to translate logical addresses to physical addresses for writes to the storage device, and maintain a log of a most recent N writes, wherein N represents a configurable amount of data, and wherein the controller is to cause the storage device to maintain stale data for the most recent N writes.

In one embodiment, N indicates a number of writes that occur within a time period. In one embodiment, N indicates a number of writes that represent an amount of storage capacity. In one embodiment, the controller is to expose an application data interface to allow changing an active state of the storage device back to anywhere from 1 to N writes ago. In one embodiment, the controller is to expose an application data interface to allow reading a state of the storage device back to anywhere from 1 to N writes ago without changing an active state of the storage device. In one embodiment, N comprises a user-selected setting to indicate a rollback capability. In one embodiment, maintain the stale data comprises the controller to prevent garbage collection or defragmentation. In one embodiment, the nonvolatile storage device comprises an embedded storage device embedded on a common hardware platform with the processor. In one embodiment, the log comprises entries to indicate a logical block address and one or more physical addresses associated with stale data. In one embodiment, the write comprises a modification of data already stored on the nonvolatile storage medium. In one embodiment, the nonvolatile storage medium comprises flash memory. In one embodiment, the nonvolatile storage medium comprises either a hard disk drive or a serial peripheral interface storage device. In one embodiment, the nonvolatile storage device comprises a solid state drive (SSD). In one embodiment, the controller comprises a controller on a host separate from a solid state drive. In one embodiment, the controller is further to receive a rollback request as a secured command, and is to execute the rollback request only after verification of the secured command. In one embodiment, the controller is further to maintain the log based at least in part on priority of the data, wherein data associated with a logical address identified as priority data is to be maintained in the log ahead of data having a lower priority. In one embodiment, the controller is further to maintain the log based at least in part on priority of the data, wherein the controller is to automatically prioritize data based on file usage. In one embodiment, comprising one or more of: wherein the host processor comprises a multicore central processing unit (CPU); a display communicatively coupled to the processor; a battery to power the computer system; or a network interface communicatively coupled to the processor.

In one aspect, a method for writing data to a nonvolatile storage medium includes: receiving a write request for a logical address of a nonvolatile storage medium; executing the write request by writing to an unused physical address as active data; associating the logical address with the unused physical address; and logging a previous physical address for the logical address as stale data, to maintain data at the previous physical address for N writes, wherein N represents a configurable amount of data.

In one embodiment, N indicates a number of writes that occur within a time period. In one embodiment, N indicates a number of writes that represent an amount of storage capacity. In one embodiment, further comprising: exposing an application data interface to allow changing an active state of the nonvolatile storage medium back to anywhere from 1 to N writes ago. In one embodiment, further comprising: exposing an application data interface to allow reading a state of the nonvolatile storage medium back to anywhere from 1 to N writes ago without changing an active state of the nonvolatile storage medium. In one embodiment, N comprises a user-selected setting to indicate a rollback capability. In one embodiment, maintaining the stale data comprises preventing garbage collection or defragmentation. In one embodiment, logging the previous physical address comprises generating log entries to indicate a logical block address and one or more physical addresses associated with stale data. In one embodiment, the write request comprises a request to modify data already stored on the nonvolatile storage medium. In one embodiment, the nonvolatile storage medium comprises flash memory. In one embodiment, the nonvolatile storage medium comprises either a hard disk drive or a serial peripheral interface storage device. In one embodiment, the controller comprises a controller on a solid state drive (SSD). In one embodiment, the controller comprises a controller on a host separate from a solid state drive. In one embodiment, the controller is further to receive a rollback request as a secured command, and is to execute the rollback request only after verification of the secured command. In one embodiment, logging the previous physical address comprises maintaining a log based at least in part on priority of the data, wherein data associated with a logical address identified as priority data is to be maintained in the log ahead of data having a lower priority. In one embodiment, logging the previous physical address comprises maintaining a log based at least in part on priority of the data, including automatically prioritizing data based on file usage.

In one aspect, an apparatus comprising means for performing a method in accordance with any embodiment of the method of the preceding two paragraphs. In one aspect, an article of manufacture comprising a computer readable storage medium having content stored thereon to provide instructions to cause a machine to perform in accordance with any embodiment of the method of the preceding two paragraphs.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. An apparatus to interface with storage resources, comprising:
a hardware interface to couple to a nonvolatile storage medium; and
a controller to translate logical addresses to physical addresses for writes to the nonvolatile storage medium, wherein the controller is to maintain a log of a most recent N writes, wherein N represents a configurable amount of data, and wherein the controller is to write data to unused physical addresses as active data, and maintain stale data for the most recent N writes.

2. The apparatus of claim 1, wherein N indicates a number of writes that occur within a time period.

3. The apparatus of claim 1, wherein N indicates a number of writes that represent an amount of storage capacity.

4. The apparatus of claim 1, wherein the controller is to expose an application data interface to allow changing an active state of the nonvolatile storage medium back to anywhere from 1 to N writes ago.

5. The apparatus of claim 1, wherein the controller is to expose an application data interface to allow reading a state of the nonvolatile storage medium back to anywhere from 1 to N writes ago without changing an active state of the nonvolatile storage medium.

6. The apparatus of claim 1, wherein N comprises a user-selected setting to indicate a rollback capability.

7. The apparatus of claim 1, wherein to maintain the stale data comprises the controller to prevent garbage collection or defragmentation.

8. The apparatus of claim 1, wherein the log comprises entries to indicate a logical block address and one or more physical addresses associated with stale data.

9. The apparatus of claim 1, wherein the write comprises a modification of data already stored on the nonvolatile storage medium.

10. The apparatus of claim 1, wherein the nonvolatile storage medium comprises flash memory.

11. The apparatus of claim 1, wherein the nonvolatile storage medium comprises either a hard disk drive or a serial peripheral interface storage device.

12. The apparatus of claim 1, wherein the controller comprises a controller on a solid state drive (SSD).

13. The apparatus of claim 1, wherein the controller comprises a controller on a host separate from a solid state drive.

14. The apparatus of claim 1, wherein the controller is further to receive a rollback request as a secured command, and is to execute the rollback request only after verification of the secured command.

15. The apparatus of claim 1, wherein the controller is further to maintain the log based at least in part on priority of the data, wherein data associated with a logical address identified as priority data is to be maintained in the log ahead of data having a lower priority.

16. The apparatus of claim 1, wherein the controller is further to maintain the log based at least in part on priority of the data, wherein the controller is to automatically prioritize data based on file usage.

17. A computer system, comprising:
a host processor;
a nonvolatile storage device to store data processed by the host processor, wherein the storage device is to write modifications to data to unused physical addresses as active data; and
a controller to translate logical addresses to physical addresses for writes to the storage device, and maintain a log of a most recent N writes, wherein N represents a configurable amount of data, and wherein the controller is to cause the storage device to maintain stale data for the most recent N writes.

18. The computer system of claim 17, wherein the controller is to expose an application data interface to allow changing an active state of the storage device back to anywhere from 1 to N writes ago.

19. The computer system of claim 17, wherein the controller is to expose an application data interface to allow reading a state of the storage device back to anywhere from 1 to N writes ago without changing an active state of the storage device.

20. The computer system of claim 17, wherein to maintain the stale data comprises the controller to prevent garbage collection or defragmentation.

21. The computer system of claim 17, wherein the nonvolatile storage device comprises an embedded storage device embedded on a common hardware platform with the processor.

22. The computer system of claim 17, wherein the nonvolatile storage device comprises a solid state drive (SSD).

23. The computer system of claim 17, comprising one or more of:
wherein the host processor comprises a multicore central processing unit (CPU);
a display communicatively coupled to the processor;
a battery to power the computer system; or a network interface communicatively coupled to the processor.

24. A method for writing data to a nonvolatile storage medium, comprising:
receiving a write request for a logical address of a nonvolatile storage medium;
executing the write request by writing to an unused physical address as active data;
associating the logical address with the unused physical address; and
logging a previous physical address for the logical address as stale data, to maintain data at the previous physical address for N writes, wherein N represents a configurable amount of data.

25. The method of claim 23, further comprising:
exposing an application data interface to allow changing an active state of the nonvolatile storage medium back to anywhere from 1 to N writes ago.

26. The method of claim 23, further comprising:
exposing an application data interface to allow reading a state of the nonvolatile storage medium back to anywhere from 1 to N writes ago without changing an active state of the nonvolatile storage medium.
